(19) United States
(12) Patent Application Publication
(10) Pub. No.: US 2012/0143460 A1
(43) Pub. Date: Jun. 7, 2012

(54) ENGINE CONTROL APPARATUS FOR WORKING MACHINE

(75) Inventors: Naoki SUGANO, Kobe-shi (JP); Satoshi Maekawa, Kobe-shi (JP); Takahiro Kobayashi, Akashi-shi (JP)

(73) Assignees: Kobelco Cranes Co., Ltd., Shinagawa-ku (JP); KABUSHIKI KAISHA KOBE SEIKO SHO (KOBE STEEL, LTD.), Kobe-shi (JP)

(21) Appl. No.: 13/311,082

(22) Filed: Dec. 5, 2011

(30) Foreign Application Priority Data
Dec. 7, 2010 (JP) 2010-272943

(51) Int. Cl. F02D 28/00

(52) U.S. Cl. 701/101

(57) ABSTRACT

An engine control apparatus includes a governor and a controller which derives a lever operation-related rotational speed control target value derives an accelerator operation-related rotational speed control target value-corresponding to a detected operation amount of the accelerator member, based on an accelerator operation/rotational speed correlation function defining a relationship between the rotational speed control target value and the operation amount of the accelerator member; performs a lower value selection for selecting a lower one of the derived lever operation-related rotational speed control target value and accelerator operation-related rotational speed control target value; and causes the governor to control the rotational speed of the engine such that the rotational speed of the engine is set to the rotational speed control target value selected by the lower value selection.

### BACKGROUND OF THE INVENTION

1. Field of the Invention

The present invention relates to an engine control apparatus for a working machine.

2. Background Art

Heretofore, in the field of working machines such as a crane, it has been known to control a rotational speed of an engine, based on an operation amount of an accelerator and an operation amount of a manipulation lever for manipulating a working device. JP 2001-151499A discloses an engine control apparatus designed to perform such control.

The engine control apparatus disclosed in the above patent publication is used in a high-altitude working vehicle for performing high-altitude work. This high-altitude working vehicle comprises a vehicle body, and a high-altitude working device mounted on the vehicle body. The vehicle body is further mounted with an engine, and a hydraulic pump adapted to be driven by power of the engine. The high-altitude working device is adapted to be driven by an oil pressure supplied from the hydraulic pump. The high-altitude working device comprises a work platform for allowing an operator to ride thereon. The work platform is provided with an accelerator switch, and a manipulation lever for manipulating the high-altitude working device.

The patent publication describes that the engine control apparatus sets a rotational speed of the engine according to an operation amount of the accelerator switch and sets the rotational speed of the engine according to an operation amount of the manipulation lever. Specifically, the engine control apparatus comprises an electronic governor device for controlling the rotational speed of the engine, an electronic control unit for controlling actuation of the electronic governor device, and a work-platform control unit capable of outputting a signal depending on manual operation of the accelerator switch and a signal depending on manual operation of the manipulation lever, to the electronic control unit. When the accelerator switch is operated manually, the work-platform control unit outputs a signal depending on the manual operation of the accelerator switch, to the electronic control unit, and then the electronic control unit causes the electronic governor device to control the rotational speed of the engine in such a manner that the rotational speed of the engine is set to a value corresponding to the signal input from the work-platform control unit into the electronic control unit, i.e., a value corresponding to an operation amount of the accelerator switch. On the other hand, when the manipulation lever is manually operated, the work-platform control unit outputs a signal depending on the manual operation of the manipulation lever, to the electronic control unit, and then the electronic control unit causes the electronic governor device to control the rotational speed of the engine in such a manner that the rotational speed of the engine is set to a value corresponding to the signal input from the work-platform control unit into the electronic control unit, i.e., a value corresponding to an operation amount of the manipulation lever.

However, in the patent publication, there is no consideration of a situation where the accelerator switch and the manipulation lever are manually and simultaneously operated. When respective manual operations of the accelerator switch and the manipulation lever are simultaneously performed, the electronic control unit is liable to become impossible to determine which of an operation amount of the accelerator switch and an operation amount of the manipulation lever should be selected to cause the electronic governor device to control the rotational speed of the engine.

In this case, if the electronic control unit gives priority to engine rotational speed control depending on an operation amount of the accelerator switch, the rotational speed of the engine will never be changed according to an operation amount of the manipulation lever even if the manipulation lever is manually operated. Consequently, for example, the rotational speed of the engine can be unnecessarily increased along with an increase in the operation amount of the accelerator switch although the manipulation lever has a small operation amount, which causes a problem of deterioration in fuel economy. On the other hand, if the electronic control unit gives priority to engine rotational speed control depending on an operation amount of the manipulation lever over the engine rotational speed control depending on an operation amount of the accelerator switch, the rotational speed of the engine will never be changed according to an operation amount of the accelerator switch even if the accelerator switch is manually operated. Heretofore, among working machine operators, there has been a demand seeking to adjust a rotational speed of an engine according to manual operation of an accelerator during manipulation of a working device. If the rotational speed of the engine is not changed according to an operation amount of the accelerator switch as in the above control apparatus, it is impossible to meet the operator's demand.

### SUMMARY OF THE INVENTION

It is an object of the present invention to provide an engine control apparatus for a working machine, which is capable of setting a rotational speed of an engine even when an accelerator and a manipulation lever are simultaneously operated, while achieving improvement in fuel economy and engine rotational speed control based on the operation of the accelerator during manipulation of a working device.

According to one aspect of the present invention, there is provided an engine control apparatus for use in a working machine which includes an engine for generating power, a working device performing a given movement using the power generated by the engine, an accelerator member operated for changing a rotational speed of the engine, and a manipulation lever operated for actuating the working device, wherein the engine control apparatus controls the rotational speed of the engine. The engine control apparatus comprises: a governor attached to the engine to control the rotational speed of the engine; and a controller which derives a lever operation-related rotational speed control target value which is a rotational speed control target value corresponding to a detected operation amount of the manipulation lever, based on a lever operation/rotational speed correlation function defining a relationship between a rotational speed control target value for the engine and an operation amount of the manipulation lever; derives an accelerator operation-related rotational speed control target value which is a rotational speed control target value corresponding to a detected operation amount of the accelerator member, based on an accelerator operation/rotational speed correlation function defining a relationship between the rotational speed control target value and the operation amount of the accelerator member; performs a lower value selection for selecting a lower one of the derived lever operation-related rotational speed control target value and accelerator operation-related rotational speed control target value; and causes the governor to control the rotational speed of the engine in such a manner that the rotational speed of the engine is set to the rotational speed control target value selected by the lower value selection.

According to another aspect of the present invention, there is provided an engine control apparatus for use in a working machine which includes an engine for generating power, a working device performing a given movement using the power generated by the engine, an accelerator member operated for changing a rotational speed of the engine, and a manipulation lever operated for actuating the working device, wherein the engine control apparatus controls the rotational speed of the engine. The engine control apparatus comprises: a governor attached to the engine to control the rotational speed of the engine; and a controller which derives a rotational speed control command value which is a rotational speed control target value corresponding to both of a detected operation amount of the manipulation lever and a detected operation amount of the accelerator member, based on a primary correlation function which defines a mutual relationship of a rotational speed control target value for the engine, an operation amount of the manipulation lever and an operation amount of the accelerator member, and includes a region where the rotational speed control target value increases or decreases along with an increase or decrease in the operation amount of the manipulation lever and a region where the rotational speed control target value increases or decreases along with an increase or decrease in the operation amount of the accelerator member; and causes the governor to control the rotational speed of the engine in such a manner that the rotational speed of the engine is set to the derived rotational speed control command value.

### BRIEF DESCRIPTION OF THE DRAWINGS

FIG. 1 is a block diagram illustrating an engine control apparatus according to a first embodiment of the present invention, and a working machine employing the engine control apparatus.

FIG. 2 is a graph illustrating a lever operation/rotational speed correlation function defining a relationship between an engine rotational speed setting value and an operation amount of a manipulation lever, in the first embodiment.

FIG. 3 is a graph illustrating an accelerator operation/rotational speed correlation function defining a relationship between the engine rotational speed setting value and an operation amount of an accelerator pedal, in the first embodiment.

FIG. 4 is a graph illustrating a correlation between the engine rotational speed setting value and an acceleration signal value.

FIG. 5 is a graph illustrating a correlation between the operation amount of the manipulation lever and the acceleration signal value, in each of three cases where the operation amount of the accelerator pedal is at its maximum value, at its minimum value and at an intermediate value therebetween.

FIG. 6 is a graph illustrating a correlation between the operation amount of the manipulation lever and an engine rotational speed, in the case where the operation amount of the accelerator pedal is the maximum value, in the first embodiment.

FIG. 7 is a graph illustrating a correlation between the operation amount of the manipulation lever and the engine rotational speed, in the case where the operation amount of the accelerator pedal is the intermediate value, in the first embodiment.

FIG. 8 is a graph illustrating a correlation between the operation amount of the manipulation lever and the engine rotational speed, in the case where the operation amount of the accelerator pedal is the minimum value, in the first embodiment.

FIG. 9 is a flowchart illustrating an engine rotational speed control process to be performed by the engine control apparatus according to the first embodiment when the manipulation lever and the accelerator pedal are simultaneously operated.

FIG. 10 is a flowchart illustrating an engine rotational speed control process to be performed by an engine control apparatus according to a second embodiment of the present invention when the manipulation lever and the accelerator pedal are simultaneously operated.

FIG. 11 is a graph illustrating a correlation between the operation amount of the manipulation lever and the engine rotational speed setting value, in each of three cases where the operation amount of the accelerator pedal is at its maximum value, at its minimum value and at an intermediate value therebetween, in an engine control apparatus according to a third embodiment of the present invention.

FIG. 12 is a graph illustrating a correlation between the operation amount of the accelerator pedal and the engine rotational speed setting value, in the case where the operation amount of the accelerator pedal is the maximum value, in the third embodiment.

FIG. 13 is a graph illustrating a correlation between the operation amount of the accelerator pedal and the engine rotational speed setting value, in the case where the operation amount of the accelerator pedal is the minimum value, in the third embodiment.

FIG. 14 is a flowchart illustrating an engine rotational speed control process to be performed by the engine control apparatus according to the third embodiment when the manipulation lever and the accelerator pedal are simultaneously operated.

FIG. 15 is a flowchart illustrating an engine rotational speed control process to be performed by an engine control apparatus according to a fourth embodiment of the present invention when the manipulation lever and the accelerator pedal are simultaneously operated.

FIG. 16 is a block diagram illustrating an engine control apparatus as an example of modification of the embodiments of the present invention, and a working machine employing the engine control apparatus.

FIG. 17 is a graph illustrating a correlation between the operation amount of the manipulation lever and the engine rotational speed, in each of three cases where the operation amount of the accelerator pedal is at its maximum value, at its minimum value and at an intermediate value therebetween, when a mode switching device is in an accelerator operation-based rotational speed control mode in the modified embodiment illustrated in FIG. 16.

FIG. 18 is a graph illustrating a correlation between the engine rotational speed setting value and the operation amount of the manipulation lever, in each of three cases where the operation amount of the accelerator pedal is at its maximum value, at its minimum value and at an intermediate value therebetween, in another example of the modification of the embodiments of the present invention.

FIG. 19 is a graph illustrating a correlation between the engine rotational speed setting value and the operation amount of the manipulation lever, in each of three cases where the operation amount of the accelerator pedal is at its maximum value, its minimum value and an intermediate value therebetween, in yet another example of the modification of the embodiments of the present invention.

### DETAILED DESCRIPTION OF THE EMBODIMENTS OF THE INVENTION

Hereinafter, embodiments of the present invention will be described with reference to the drawings.

### First Embodiment

A configuration of a working machine employing an engine control apparatus 1 according to a first embodiment of the present invention will be firstly described.

The engine control apparatus 1 according to the first embodiment is used in a working machine such as a crane. The crane comprises a non-illustrated lower body, a non-illustrated upper slewing body mounted on the lower body slewably about a vertical axis, and a non-illustrated raisable and lowerable member provided on the upper slewing body in a raisable and lowerable manner. The crane is designed to perform load suspending work using a non-illustrated main hoist hook device suspended from a tip of the raisable and lowerable member through a main hoist rope, and a non-illustrated auxiliary hoist hook device suspended from the tip of the raisable and lowerable member through an auxiliary hoist rope.

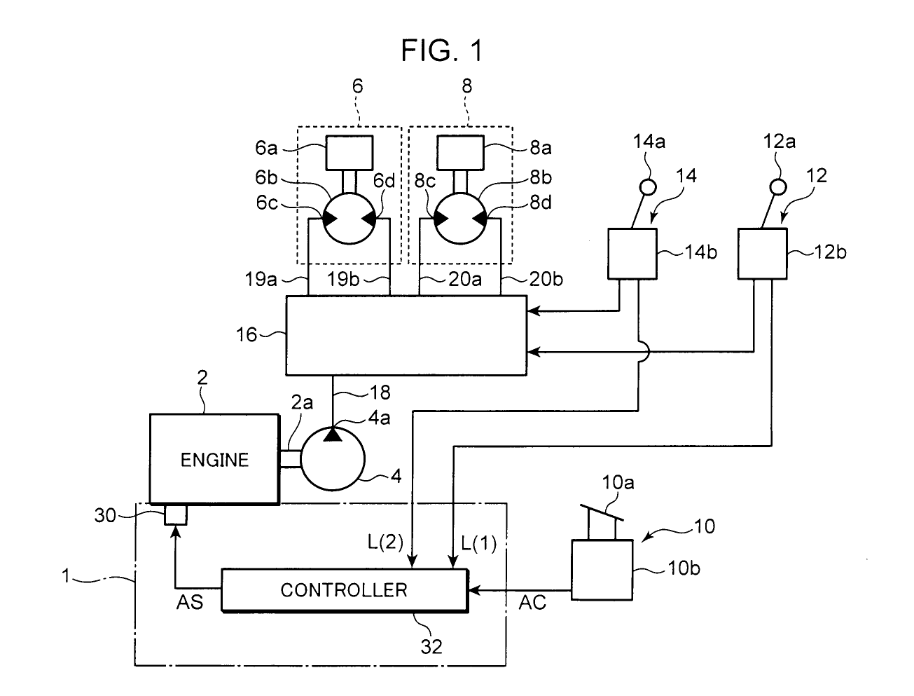

The working machine employing the engine control apparatus 1 has a configuration illustrated in FIG. 1. Specifically, the working machine comprises an engine 2, a hydraulic pump 4, a first working device 6, a second working device 8, an accelerator device 10, a first-working-device manipulation device 12, a second-working-device manipulation device 14, and a control valve 16.

The engine 2 is adapted to operate to generate power. The engine 2 has a drive shaft 2a connected to the hydraulic pump 4. The engine 2 supplies power to the hydraulic pump 4 via the drive shaft 2a.

The hydraulic pump 4 is actuated by the power supplied from the engine 2, to discharge pressure oil therefrom. The hydraulic pump 4 has an outlet port 4a connected to the control valve 16 via a supply passage 18. The hydraulic pump 4 supplies pressure oil from the outlet port 4a to the control valve 16 through the supply passage 18. A rotational speed of the hydraulic pump 4 is increased or reduced along with an increase or decrease in rotational speed of the engine 2. Further, a flow rate of pressure oil to be discharged from the hydraulic pump 4 is increased or reduced along with an increase or decrease in rotational speed of the hydraulic pump 4.

Each of the first working device 6 and the second working device 8 is encompassed within the concept of “working device” set forth in the appended claims.

Each of the first and second working devices 6, 8 performs a given movement indirectly using the power of the engine 2. More specifically, the power of the engine 2 is converted into oil pressure, and the oil pressure is supplied from the hydraulic pump 4 to cause each of the first and second working devices 6, 8 to perform a given movement. For example, each of the first and second working devices 6, 8 may be one selected from the group consisting of: a raising and lowering device for raising and lowering the raisable and lowerable member; a turning device for turning the upper slewing body; a main hoist winch for winding or unwinding the main hoist rope so as to hoist the main hoist hook device up or down; and an auxiliary hoist winch for winding or unwinding the auxiliary hoist rope so as to hoist the auxiliary hoist hook device up or down. The first and second working devices 6, 8 are designed to perform different movements (different works), respectively.

The first working device 6 comprises a first movable member 6a, and a first actuator 6b for driving the first movable member 6a. The second working device 8 comprises a second movable member 8a, and a second actuator 8b for driving the second movable member 8a.

Each of the first and second movable members 6a, 8a is driven by a respective one of the first and second actuators 6b, 8b, to perform a given movement. For example, in cases where the working device 6 (8) is the slewing device, the movable member 6a (8a) corresponds to the upper slewing body. In cases where the working device 6 (8) is a winch for performing hoist-up/hoist-down of a hook device, the movable member 6a (8a) corresponds to a drum of the winch. Each of the actuators 6b, 8b is composed of a hydraulic motor which is driven by the pressure oil discharged from the hydraulic pump 4. Specifically, the first actuator 6b has two inlet ports 6c, 6d for receiving the pressure oil. One inlet port 6c of the two inlet ports is connected to the control valve 16 via an oil passage 19a, and the other inlet port 6d is connected to the control valve 16 via an oil passage 19b. The pressure oil supplied from the hydraulic pump 4 to the control valve 16 through the supply passage 18 is supplied from the control valve 16 to the first actuator 6b through one of the oil passages 19a, 19b. The first actuator 6b is moved in opposite rotational directions between when the pressure oil is supplied to the one inlet port 6c and when the pressure oil is supplied to the other inlet port 6d, to drive the first movable member 6a in opposite moving directions corresponding to respective ones of the rotational directions. Further, the first actuator 6b is moved at a rotational speed corresponding to a flow rate of the supplied pressure oil so as to drive the first actuator 6b at a speed corresponding to the rotational speed. The second actuator 8b has two inlet ports 8c, 8d for receiving the pressure oil. One inlet port 8c of the two inlet ports is connected to the control valve 16 via an oil passage 20a, and the other inlet port 8d is connected to the control valve 16 via an oil passage 20b. The pressure oil is supplied from the control valve 16 to the second actuator 8b through one of the oil passages 20a, 20b, in the same manner as that in the first actuator 6b. Depending on the supply routes, the second actuator 8b is moved to drive the second movable member 8a in the same manner as that in the first actuator 6b.

The accelerator device 10 is used to change the rotational speed of the engine 2. The accelerator device 10 comprises an accelerator pedal 10a and an accelerator device body 10b. The accelerator pedal 10a is operated by operator's foot for changing the rotational speed of the engine 2. The accelerator pedal 10a is encompassed within the concept of “accelerator member” set forth in the appended claims. The accelerator device body 10b supports the accelerator pedal 10a to allow the accelerator pedal 10a to be moved upwardly and downwardly, and outputs an acceleration instruction signal indicative of a depression amount (operation amount) of the accelerator pedal 10a to an aftermentioned controller 32 of the engine control apparatus 1.

The first-working-device manipulation device 12 is used to manipulate the first working device 6. The first-working-device manipulation device 12 comprises a first manipulation lever 12a, and a first manipulation device body 12b. The first manipulation lever 12a is operated by operator's hand for actuating the first working device 6. The first manipulation device body 12b supports the first manipulation lever 12a in such a manner that the first manipulation lever 12a can be tilted from a neutral position toward one side and the other, opposite, side, about a base end thereof serving as a support point. The first manipulation device body 12b outputs a first manipulation instruction signal indicative of an operation direction (tilt direction) of the first manipulation lever 12a with respect to the neutral position, and an operation amount (tilt amount) of the first manipulation lever 12a with respect to the neutral position, to the control valve 16 and the aftermentioned controller 32.

The second-working-device manipulation device 14 is used to manipulate the second working device 8. The second-working-device manipulation device 14 comprises a second manipulation lever 14a, and a second manipulation device body 14b. The second manipulation lever 14a is operated by operator's hand for actuating the second working device 8. The second manipulation device body 14b supports the second manipulation lever 14a in such a manner that the second manipulation lever 14a can be tilted from a neutral position toward one side and the other, opposite, side, about a base end thereof serving as a support point. The second manipulation device body 14b outputs a second manipulation instruction signal indicative of an operation direction (tilt direction) of the second manipulation lever 14a with respect to the neutral position, and an operation amount (tilt amount) of the second manipulation lever 14a with respect to the neutral position, to the control valve 16 and the aftermentioned controller 32.

The control valve 16 supplies, in response to manual operation of the first manipulation lever 12a, pressure oil to one of the two inlet ports 6c, 6d of the first actuator 6b, which corresponds to the operation direction of the first manipulation lever 12a, while controlling a flow rate of pressure oil to be supplied, in accordance with the operation amount of the first manipulation lever 12a. Further, the control valve 16 supplies, in response to manual operation of the second manipulation lever 14a, pressure oil to one of the two inlet ports 8c, 8d of the second actuator 8b, which corresponds to the operation direction of the second manipulation lever 14a, while controlling a flow rate of pressure oil to be supplied, in accordance with the operation amount of the second manipulation lever 14a.

More specifically, the control valve 16 is provided between the supply passage 18 communicated with the outlet port 4a of the hydraulic pump 4 and each of the oil passages 19a, 19b, 20a, 20b communicated with the first and second actuators 6b, 8b. The control valve 16 supplies, in response to receiving a first manipulation instruction signal output from the first manipulation device body 12b, pressure oil to an associated one of the inlet ports 6c, 6d of the first actuator 6b through the oil passage 19a or 19b corresponding to the operation direction of the first manipulation lever 12a indicated by the first manipulation instruction signal at an flow rate corresponding to the operation amount of the first manipulation lever 12a indicated by the first manipulation instruction signal. Further, the control valve 16 supplies, in response to receiving a second manipulation instruction signal output from the second manipulation device body 14b, pressure oil to an associated one of the inlet ports 8c, 8d of the second actuator 8b through the oil passage 20a or 20b corresponding to the operation direction of the second manipulation lever 14a indicated by the second manipulation instruction signal at an flow rate corresponding to the operation amount of the second manipulation lever 14a indicated by the second manipulation instruction signal.

According to the above function of the control valve 16, the first actuator 6b is driven in a rotational direction corresponding to the operation direction of the first manipulation lever 12a at a speed corresponding to the operation amount of the first manipulation lever 12a, and accordingly the first movable member 6a is driven in a direction corresponding to the operation direction of the first manipulation lever 12a at a speed corresponding to the operation amount of the first manipulation lever 12a. Further, the second actuator 8b is driven in a rotational direction corresponding to the operation direction of the second manipulation lever 14a at a speed corresponding to the operation amount of the second manipulation lever 14a, and accordingly the second movable member 8a is driven in a direction corresponding to the operation direction of the second manipulation lever 14a at a speed corresponding to the operation amount of the second manipulation lever 14a.

The engine control apparatus 1 according to the first embodiment is used in the working machine having the above configuration. The engine control apparatus 1 controls the rotational speed of the engine 2. A specific configuration of the engine control apparatus 1 will be described below.

As illustrated in FIG. 1, the engine control apparatus 1 comprises a governor 30 and a controller 32.

The governor 30 is attached to the engine 2. The governor 30 is designed to actually change and control the rotational speed of the engine 2.

The controller 32 causes the governor 30 to control the rotational speed of the engine 2 in such a manner that the rotational speed of the engine 2 is set to a lower one between a higher one of two rotational speed values each corresponding to a detected operation amount of a respective one of the first and second manipulation levers 12a, 14a, and a rotational speed value corresponding to a detected operation amount of the accelerator pedal 10a.

Specifically, the controller 32 calculates an engine rotational speed setting value EN1(1) corresponding to a detected operation amount of the first manipulation lever 12a and an engine rotational speed setting value EN1(2) corresponding to a detected operation amount of the second manipulation lever 14a; performs a maximum value selection for selecting a maximum one of the calculated engine rotational speed setting values EN1(1), EN1(2); calculates an engine rotational speed setting value EN2 corresponding to a detected operation amount of the accelerator pedal 10a; performs a lower value selection for selecting a lower one of the engine rotational speed setting value EN1(1) or EN1(2) selected by the maximum value selection and the calculated engine rotational speed setting value EN2; and performs control for causing the governor 30 to adjust the engine rotational speed according to the rotational speed setting value selected by the lower value selection. The engine rotational speed setting value is a value to which the rotational speed of the engine 2 is to be set in a designated manner, and encompassed within the concept of “rotational speed control target value” set forth in the appended claims.

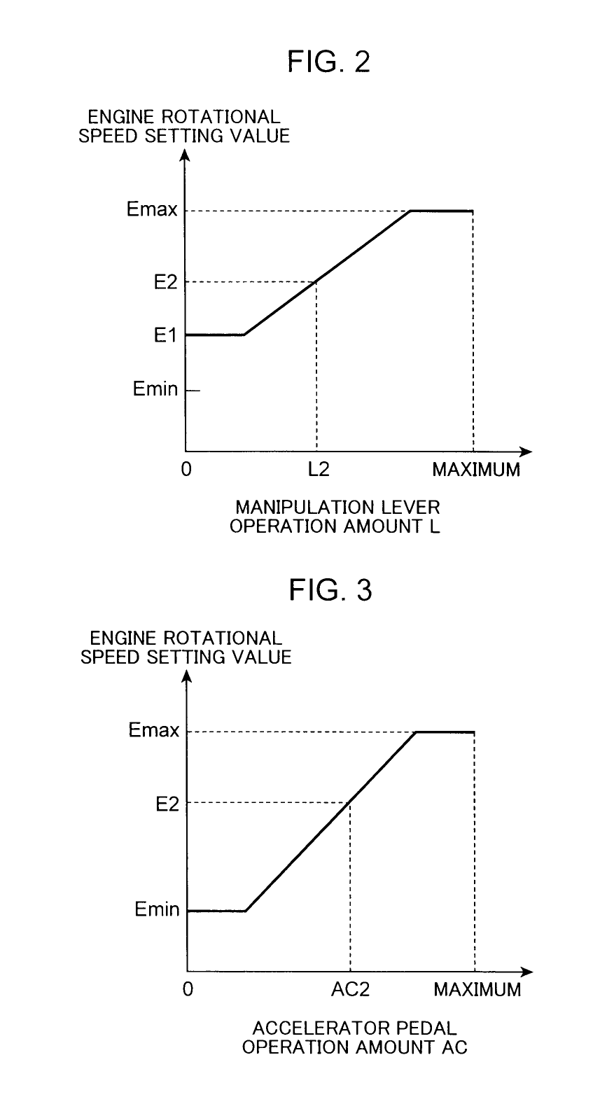

In the process of calculating the engine rotational speed setting values EN1(1), EN1(2), the controller 32 calculates these values in response to receiving first and second manipulation instruction signals output from respective ones of the first and second manipulation device bodies 12b, 14b. Specifically, the controller 32 calculates, in response to receiving a first manipulation instruction signal output from the first manipulation device body 12b, an engine rotational speed setting value EN1(1) corresponding to an operation amount of the first manipulation lever 12a indicated by and detected from the first manipulation instruction signal, based on a lever operation/rotational speed correlation function, and, calculates, in response to receiving a second manipulation instruction signal output from the second manipulation device body 14b, an engine rotational speed setting value EN1(2) corresponding to an operation amount of the second manipulation lever 14a indicated by and detected from the second manipulation instruction signal, based on the lever operation/rotational speed correlation function. The lever operation/rotational speed correlation function (see FIG. 2) is a function defining a relationship between an engine rotational speed setting value and an operation amount L of the first or second manipulation lever. The lever operation/rotational speed correlation function includes a region where the engine rotational speed setting value increases or decreases along with an increase or decrease in the operation amount L of the manipulation lever. Specifically, in the lever operation/rotational speed correlation function, when the operation amount L of the first or second manipulation lever is in a region between a zero point and a point slightly greater than the zero point, the engine rotational speed setting value is kept constant at a value slightly greater than a minimum value Emin of the rotational speed of the engine 2. Further, when the operation amount L of the first or second manipulation lever is in a region between a maximum point and a point slightly less than the maximum point, the engine rotational speed setting value is kept constant at a value equal to a maximum value Emax of the rotational speed of the engine 2. On the other hand, in an intermediate region between the above two regions, the engine rotational speed setting value increases gradually and linearly along with an increase in the operation amount L of the first or second manipulation lever.

Then, the controller 32 performs a maximum (higher) value selection for selecting a maximum (higher) one of the engine rotational speed setting values EN1(1), EN1(2) calculated in the above manner, to derive the selected maximum (higher) value as a manipulation lever-related rotational speed setting value EN1. The manipulation lever-related rotational speed setting value EN1 is encompassed within the concept of “lever operation-related rotational speed control target value” set forth in the appended claims.

In the process of calculating an engine rotational speed setting value corresponding to a detected operation amount of the accelerator pedal 10a, the controller 32 calculates the setting value in response to receiving an acceleration instruction signal output from the accelerator device body 10b. Specifically, the controller 32 calculates, in response to receiving an acceleration instruction signal output from the accelerator device body 10b, an engine rotational speed setting value corresponding to an operation amount of the accelerator pedal 10a indicated by and detected from the acceleration instruction signal, as an accelerator-related rotational speed setting value EN2. The controller 32 calculates the engine rotational speed setting value as an accelerator-related rotational speed setting value EN2, based on an accelerator operation/rotational speed correlation function. The accelerator-related rotational speed setting value EN2 is encompassed within the concept of “accelerator operation-related rotational speed control target value” set forth in the appended claims. The accelerator operation/rotational speed correlation function (see FIG. 3) is a function defining a relationship between an engine rotational speed setting value and an operation amount of the accelerator pedal 10a. The accelerator operation/rotational speed correlation function includes a region where the engine rotational speed setting value increases or decreases along with an increase or decrease in the operation amount AC of the accelerator pedal 10a. Specifically, in the accelerator operation/rotational speed correlation function, when the operation amount AC of the accelerator pedal 10a is in a region of a zero point and a point slightly greater than the zero point, the engine rotational speed setting value is kept constant at a value equal to the minimum value Emin of the rotational speed of the engine 2. Further, in the accelerator operation/rotational speed correlation function, when the operation amount AC of the accelerator pedal 10a is in a region between a maximum point and a point slightly less than the maximum point, the engine rotational speed setting value is kept constant at a value equal to the maximum value Emax of the rotational speed of the engine 2. On the other hand, in the accelerator operation/rotational speed correlation function, when the operation amount AC of the accelerator pedal 10a is in an intermediate region between the above two regions, the engine rotational speed setting value increases gradually and linearly along with an increase in the operation amount AC of the accelerator pedal 10a.

Then, the controller 32 performs a lower value selection for selecting a lower one of the manipulation lever-related rotational speed setting value EN1 and the accelerator-related rotational speed setting value EN2 each calculated in the above manner, to derive the selected setting value as a target engine rotational speed value EN.

Then, the controller 32 causes the governor 30 to control the rotational speed of the engine 2 in such a manner that the rotational speed of the engine 2 is set to a value designated by the derived target engine rotational speed value EN. In this process, the controller 32 converts the target engine rotational speed value EN into an acceleration signal AS, and send the acceleration signal AS to the governor 30 to thereby cause the governor 30 to control the rotational speed of the engine 2.

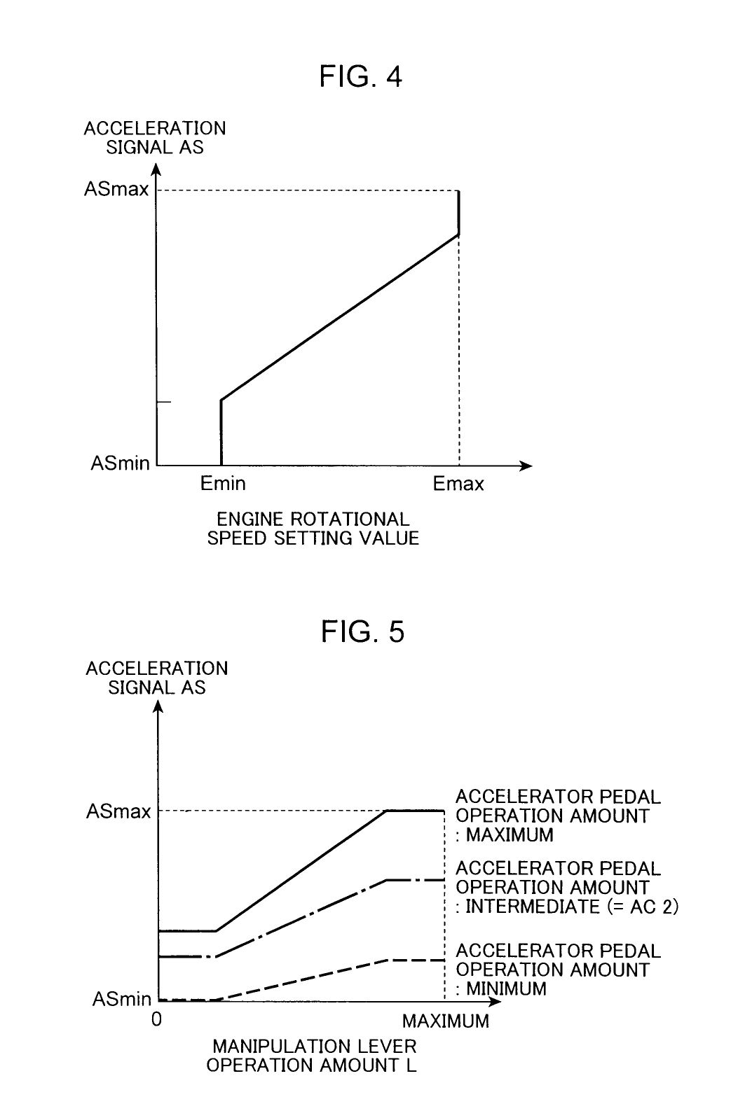

Specifically, the controller 32 calculates a value of the acceleration signal AS corresponding to the target engine rotational speed value EN, based on an acceleration signal correlation function (see FIG. 4) defining a correlation between an engine rotational speed setting value and a value of the acceleration signal AS. The acceleration signal AS is a control signal for controlling actuation of the governor 30 which adjusts the rotational speed of the engine 2. A value of the acceleration signal AS to be calculated by the controller 32, an operation amount L of a more-largely-operated one of the first and second manipulation levers, and an operation amount AC of the accelerator pedal 10a, have a correlation as illustrated in FIG. 5. Specifically, in the correlation illustrated in FIG. 5, as the operation amount AC of the accelerator pedal 10a decreases from its maximum value to its minimum value, the value of the acceleration signal AS gradually decreases as a whole. More specifically, under the condition that the operation amount AC of the accelerator pedal 10a is at its maximum value, the value of the acceleration signal AS is set to its maximum value ASmax when the operation amount of the more-largely-operated manipulation lever is equal to or near its maximum value. Under the condition that the operation amount AC of the accelerator pedal 10a is at its minimum value, the value of the acceleration signal AS is set to its minimum value ASmin when the operation amount of the more-largely-operated manipulation lever is equal to or near its minimum value. Further, as the operation amount AC of the accelerator pedal 10a decreases from its maximum value to its minimum value, an inclination in a region where the value of the acceleration signal AS increases or decreases along with an increase or decrease in the operation amount of the more-largely-operated manipulation lever (i.e., a rate of change in the value of the acceleration signal AS with respect to the operation amount of the manipulation lever) gradually decreases.

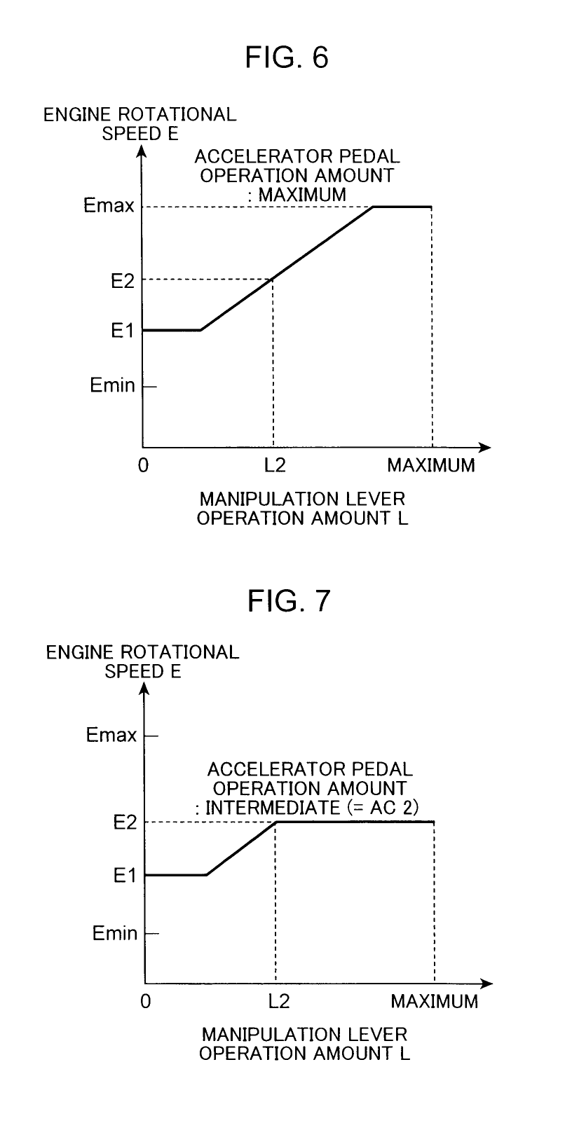

The governor 30 changes the rotational speed of the engine 2 according to a level of the value of the acceleration signal AS received from the controller 32, and thereby controls the rotational speed of the engine 2 in such a manner that the rotational speed of the engine 2 is set to a value designated by the target engine rotational speed value EN as a source converted to the acceleration signal AS. The rotational speed of the engine 2 (engine rotational speed E) to be controlled by governor 30 has relationships with the operation amount L of the manipulation lever and the operation amount AC of the accelerator pedal 10a, as illustrated in FIGS. 6 to 8.

Specifically, under the condition that the operation amount of the accelerator pedal 10a is at its maximum value, when the operation amount of the more-largely-operated manipulation lever in the first and second manipulation levers 12a, 14a is at its maximum value, each of the manipulation lever-related rotational speed setting value EN1 and the accelerator-related rotational speed setting value EN2 is set to a value equal to the maximum value Emax of the rotational speed of the engine 2, and, when the operation amount of the more-largely-operated manipulation lever is at a value less than its maximum value, the manipulation lever-related rotational speed setting value EN1 is set to a value lower than the accelerator-related rotational speed setting value EN2=Emax. Thus, the manipulation lever-related rotational speed setting value EN1 can be used as the target engine rotational speed value EN, so that, under the condition that the operation amount of the accelerator pedal 10a is at its maximum value, the operation amount of the more-largely-operated manipulation lever and the engine rotational speed E to be set by the governor 30 have a correlation (see FIG. 6) similar to that in the lever operation/rotational speed correlation function illustrated in FIG. 2.

Under the condition that the operation amount of the accelerator pedal 10a is at a value less than its maximum value, and the engine rotational speed setting value is in the region of the accelerator operation/rotational speed correlation function where it increases or decreases along with an increase or decrease in the operation amount AC of the accelerator pedal 10a, an accelerator-related rotational speed setting value EN2 corresponding to the operation amount of the accelerator pedal 10a corresponds to a maximum of the target engine rotational speed value EN. Therefore, the operation amount of the more-largely-operated manipulation lever and the engine rotational speed E to be set by the governor 30 have a correlation as illustrated in FIG. 7.

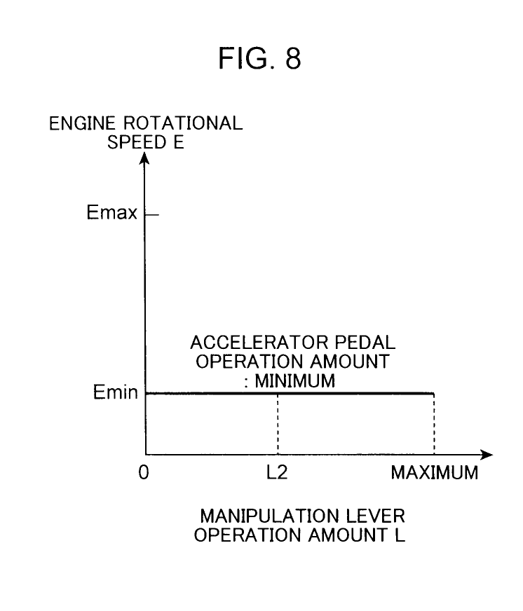

Under the condition that the operation amount of the accelerator pedal 10a is at its minimum value, an engine rotational speed setting value (accelerator-related rotational speed setting value EN2) corresponding to the minimum value of the operation amount of the accelerator pedal 10a becomes equal to the minimum value Emin of the rotational speed of the engine 2, as illustrated in FIG. 3, and becomes lower than a minimum value (see FIG. 2) of the engine rotational speed setting value (manipulation lever-related rotational speed setting value EN1) corresponding to the operation amount of the more-largely-operated manipulation lever. Thus, the target engine rotational speed value EN is fixed to the accelerator-related rotational speed setting value EN2 corresponding to the minimum value of the operation amount of the accelerator pedal 10a, irrespective of the operation amount of the manipulation lever, so that the operation amount of the more-largely-operated manipulation lever and the engine rotational speed E to be set by the governor 30 have a correlation as illustrated in FIG. 8.

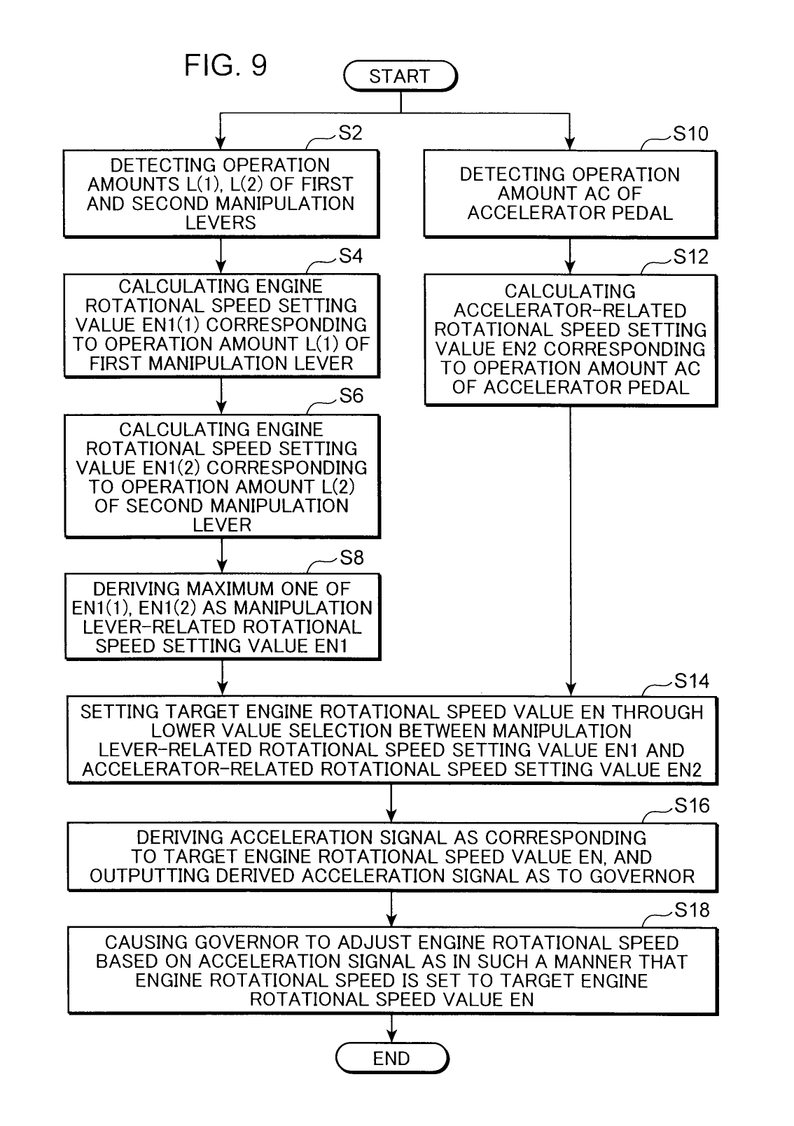

An engine rotational speed control process to be performed by the engine control apparatus 1 according to the first embodiment when the first and second manipulation levers 12a, 14a and the accelerator pedal 10a are simultaneously operated, will be described below. FIG. 9 illustrates the engine rotational speed control process to be performed by the engine control apparatus 1 according to the first embodiment.

Firstly, respective manual operations of the first and second manipulation levers 12a, 14a and the accelerator pedal 10a are simultaneously operated by an operator. In response to the operations, first and second manipulation instruction signals are output from the first and second manipulation device bodies 12b, 14b, and an acceleration instruction signal is output from the accelerator device body 10b.

The controller 32 receives the first manipulation instruction signal output from the first manipulation device body 12b to detect an operation amount L(1) of the first manipulation lever 12a indicated by the first manipulation instruction signal, and receives the second manipulation instruction signal output from the second manipulation device body 14b to detect an operation amount L(2) of the second manipulation lever 14a indicated by the second manipulation instruction signal (Step S2).

Then, the controller 32 calculates an engine rotational speed setting value EN1(1) corresponding to the detected operation amount L(1) of the first manipulation lever 12a, based on the lever operation/rotational speed correlation function (Step S4), and calculates an engine rotational speed setting value EN1(2) corresponding to the detected operation amount L(2) of the second manipulation lever 14a, based on the lever operation/rotational speed correlation function (Step S6).

Subsequently, the controller 32 performs a maximum value selection for selecting a maximum one of the engine rotational speed setting values EN1(1), EN1(2), to derive the selected maximum value as a manipulation lever-related rotational speed setting value EN1 (Step S8).

In concurrence with the above steps, the controller 32 performs a process of calculating the accelerator-related rotational speed setting value EN2.

Specifically, the controller 32 receives the acceleration instruction signal output from the acceleration device body 10b to detect an operation amount AC of the accelerator pedal 10a indicated by the received signal (Step S10).

Subsequently, based on the accelerator operation/rotational speed correlation function, the controller 32 calculates an engine rotational speed setting value corresponding to the detected operation amount AC of the accelerator pedal 10a, as an accelerator-related rotational speed setting value EN2 (Step S12).

Then, the controller 32 performs a lower value selection for selecting a lower one of the manipulation lever-related rotational speed setting value EN1 and the accelerator-related rotational speed setting value EN2, to derive the selected rotational speed setting value as a target engine rotational speed value EN (Step S14).

Subsequently, the controller 32 derives a value of the acceleration signal AS corresponding to the target engine rotational speed value EN, based on the acceleration signal correlation function, and output the derived acceleration signal AS to the governor 30 (Step S16).

Finally, the governor 30 controls the rotational speed of the engine 2 based on the acceleration signal AS in such a manner that the rotational speed of the engine 2 is set to the target engine rotational speed value EN corresponding to the acceleration signal AS (Step S18).

As described above, in the engine control apparatus 1 according to the first embodiment, the controller 32 performs a lower value selection between a manipulation lever-related rotational speed setting value EN1 derived by a maximum value selection between an engine rotational speed setting value EN1(1) corresponding to a detected operation amount of the first manipulation lever 12a and an engine rotational speed setting value EN1(2) corresponding to a detected operation amount of the second manipulation lever 14a, and an accelerator-related rotational speed setting value EN2; and causes the governor 30 to control the rotational speed of the engine 2 in such a manner that the rotational speed of the engine 2 is set to a value designated by the rotational speed setting value selected by the lower value selection. This makes it possible to determine a target value for use in adjusting the rotational speed of the engine 2, even in a situation where the first and second manipulation levers 12a, 14a and the accelerator pedal 10a are simultaneously operated, and change the rotational speed of the engine 2 to the target value.

In the first embodiment, the controller 32 causes the governor 30 to control rotational speed of the engine 2, based on the engine rotational speed setting value selected through a lower value selection between the manipulation lever-related rotational speed setting value EN1 and the accelerator-related rotational speed setting value EN2. Thus, when the manipulation lever-related rotational speed setting value EN1 corresponding to the detected operation amount of the first or second manipulation lever 12a or 14a is lower than the accelerator-related rotational speed setting value EN2 corresponding to the detected operation amount of the accelerator pedal 10a, the rotational speed of the engine 2 is set to a value corresponding to the detected operation amount of the first or second manipulation lever 12a or 14a. This prevents the occurrence of a situation where the rotational speed of the engine is unnecessarily increased along with an increase in the operation amount of the accelerator pedal 10a although each of the first and second manipulation levers 12a, 14a has a small operation amount, which makes it possible to improved fuel economy.

In the first embodiment, the controller 32 causes the governor 30 to control rotational speed of the engine 2, based on the engine rotational speed setting value selected through a lower value selection between the manipulation lever-related rotational speed setting value EN1 and the accelerator-related rotational speed setting value EN2, so that, in a range where the accelerator-related rotational speed setting value EN2 corresponding to the detected operation amount of the accelerator pedal 10a is lower than the manipulation lever-related rotational speed setting value, the engine rotational speed control is performed according to the operation of the accelerator pedal 10a. Thus, when the manipulation lever 12a (14a) is manually operated in a large amount during manipulation of the working device 6(8), the engine rotational speed control can be performed according to the operation of the accelerator pedal 10a.

In the first embodiment, the controller 32 performs a maximum value selection between the engine rotational speed setting values EN1(1), EN1(2) corresponding to the detected operation amounts of the first and second manipulation levers 12a, 14a, to derive a maximum one of the rotational speed setting values, as a manipulation lever-related rotational speed setting value EN1. Thus, in a situation where one of the first and second manipulation levers 12a, 14a is manually operated more largely than the other manipulation lever, when an engine rotational speed setting value corresponding to a detected operation amount of the more-largely-operated manipulation lever 12a or 14a is lower than the accelerator-related rotational speed setting value EN2, the rotational speed of the engine 2 is controlled according to the detected operation amount of the more-largely-operated manipulation lever 12a or 14a. In the situation one of the first and second manipulation levers 12a, 14a is manually operated more largely than the other manipulation lever, one of the working devices 6, 8 to be manipulated according to the manual operation of the more-largely-operated manipulation lever 12a or 14a is generally required to be moved quickly. In the first embodiment, the rotational speed of the engine 2 is controlled according to the detected operation amount of the more-largely-operated manipulation lever 12a or 14a. This makes it possible to controllably adjust the rotational speed of the engine 2 to a value capable of satisfying a movement speed of the working device 6 or 8 according to the manual operation of the more-largely-operated manipulation lever.

### Second Embodiment

A configuration of an engine control apparatus 1 for a working machine, according to a second embodiment of the present invention, will be described below.

The engine control apparatus 1 according to the second embodiment is used in the same working machine as that described in the first embodiment. The engine control apparatus 1 according to the second embodiment has the same configuration as that of the engine control apparatus 1 according to the first embodiment, except for the controller 32. In the second embodiment, instead of deriving a manipulation lever-related rotational speed setting value EN1 by a maximum value selection between two engine rotational speed setting values EN1(1), EN1(2) each corresponding to a detected operation amount of a respective one of the first and second manipulation levers 12a, 14a, the controller 32 selects a maximum one of respective detected operation amounts of the first and second manipulation levers 12a, 14a, and derives an engine rotational speed setting value corresponding to the selected maximum operation amount, as a manipulation lever-related rotational speed setting value EN1.

Specifically, the controller 32 selects, in response to receiving first and second manipulation instruction signals output from respective ones of the first manipulation device body 12b and the second manipulation device body 14b, a maximum one of respective operation amounts of the first and second manipulation levers 12a, 14a indicated by and detected from the first and second manipulation instruction signals. Then, the controller 32 calculates, based on a lever operation/rotational speed correlation function, an engine rotational speed setting value corresponding to the selected maximum operation amount of the maculation lever 12a or 14a, as a manipulation lever-related rotational speed setting value EN1. The lever operation/rotational speed correlation function used by the controller 32 in the second embodiment is the same as that used by the controller 32 in the first embodiment.

The remaining configuration of the engine control apparatus 1 according to the second embodiment is the same as that of the engine control apparatus 1 according to the first embodiment.

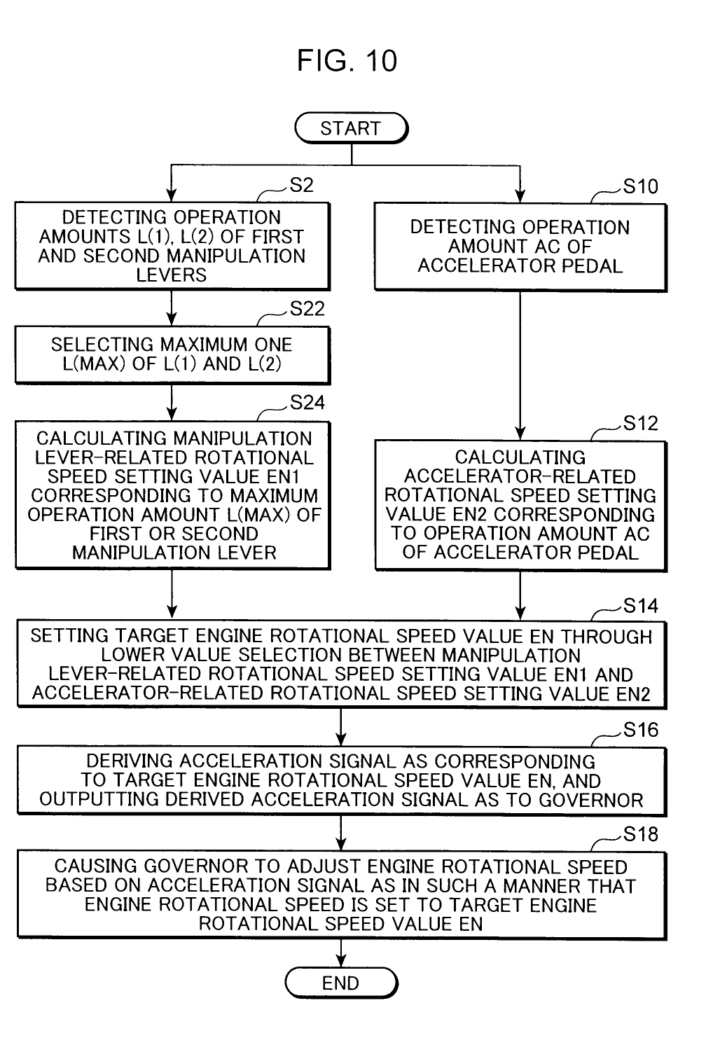

An engine rotational speed control process to be performed by the engine control apparatus 1 according to the second embodiment when the first and second manipulation levers 12a, 14a and the accelerator pedal 10a are simultaneously operated, will be described below. FIG. 10 illustrates the engine rotational speed control process to be performed by the engine control apparatus 1 according to the second embodiment.

In this engine rotational speed control process, the controller 32 firstly detects an operation amount L(1) of the first manipulation lever 12a and an operation amount L(2) of the second manipulation lever 14a (Step S2), in the same manner as the engine rotational speed control process in the first embodiment.

Then, the controller 32 selects a maximum one L(max) of the detected operation amounts L(1), L(2) of the first and second manipulation levers 12a, 14a (Step S22).

Subsequently, based on the lever operation/rotational speed correlation function, the controller 32 calculates an engine rotational speed setting value corresponding to the selected maximum operation amount L(max) of the first or second manipulation lever 12a or 14a, as a manipulation lever-related rotational speed setting value EN1 (Step S24).

In concurrence with the above Steps S2, S22, S24, the controller 32 performs detection of an operation amount AC of the accelerator pedal 10a (Step S10), and calculation of an accelerator-related rotational speed setting value EN2 as an engine rotational speed setting value corresponding to the detected operation amount AC (Step S12), in the same manner as the engine rotational speed control process in the first embodiment.

Subsequently, the controller 32 performs the same process (Steps S14, S16, S18) as that in the first embodiment to cause the governor 30 to control the engine rotational speed.

As described above, in the second embodiment, the controller 32 calculates a manipulation lever-related rotational speed setting value EN1, based on a maximum one L(max) of respective detected operation amounts L(1), L(2) of the first and second manipulation levers 12a, 14a, so that, when the manipulation lever-related rotational speed setting value EN1 corresponding to the maximum operation amount L(max) is lower than an accelerator-related rotational speed setting value EN2, the rotational speed of the engine 2 is controlled based on the detected operation amount of the more-largely-operated manipulation lever 12a or 14a. This makes it possible to controllably adjust the rotational speed of the engine 2 to a value capable of satisfying a movement speed of the working device 6 or 8 according to the manual operation of the more-largely-operated manipulation levers 12a or 14a, as with the first embodiment.

Other effects of the second embodiment are the same as those of the first embodiment.

### Third Embodiment

A configuration of an engine control apparatus 1 for a working machine, according to a third embodiment of the present invention, will be described below.

A configuration of a working machine employing the engine control apparatus 1 according to the third embodiment is the same as that of the working machine employing the engine control apparatus 1 according to the first embodiment.

In the engine control apparatus 1 according to the third embodiment, the controller 32 calculates an engine rotational speed setting value EN(1) corresponding to both of a detected operation amount of the first manipulation lever 12a and a detected operation amount of the accelerator pedal 10a, and an engine rotational speed setting value EN(2) corresponding to both of a detected operation amount of the second manipulation lever 14a and the detected operation amount of the accelerator pedal 10a; and sets a maximum one of the calculated engine rotational speed setting values EN(1), EN(2), as a target engine rotational speed value EN. In this respect, the engine control apparatus 1 according to the third embodiment is different from the engine control apparatus 1 according to the first embodiment.

Specifically, in the engine control apparatus 1 according to the third embodiment, the controller 32 calculates, in response to receiving the first manipulation instruction signal output from the first manipulation device body 12b, an engine rotational speed setting value EN(1) corresponding to both of an operation amount of the first manipulation lever 12a indicated by and detected from the first manipulation instruction signal and an operation amount of the accelerator pedal 10a indicated by and detected from the acceleration instruction signal, based on a primary correlation function, and the controller 32 further calculates, in response to receiving the second manipulation instruction signal output from the second manipulation device body 14b, an engine rotational speed setting value EN(2) corresponding to both of an operation amount of the second manipulation lever 14a indicated by and detected from the second manipulation instruction signal and the operation amount of the accelerator pedal 10a indicated by and detected from the acceleration instruction signal, based on the primary correlation function. Then, the controller 32 derives a maximum one of the calculated engine rotational speed setting values EN(1), EN(2), as a target engine rotational speed value EN. This target engine rotational speed value is encompassed within the concept of “rotational speed control command value” set forth in the appended claims.

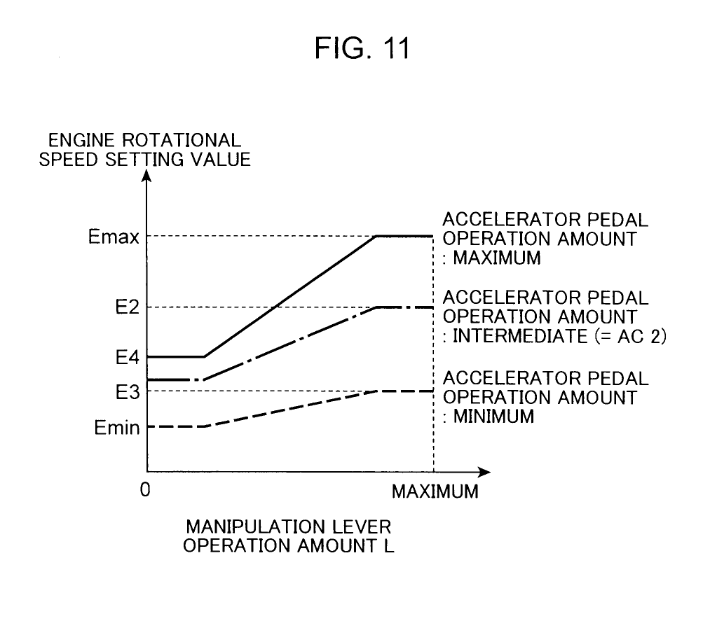

The primary correlation function (see FIG. 11) is a function defining a mutual relationship of an engine rotational speed setting value to which the engine rotational speed is to be set, an operation amount of each of the first and second manipulation levers 12a, 14a, and a manipulation amount of the accelerator pedal 10a. The primary correlation function includes a region where the engine rotational speed setting value increases or decreases along with an increase or decrease in the operation amount L of the first or second manipulation lever, and a region where the engine rotational speed setting value increases or decreases along with an increase or decrease in the operation amount AC of the accelerator pedal 10a.

More specifically, in the primary correlation function, irrespective of the operation amount AC of the accelerator pedal 10a, when the operation amount L of the first or second manipulation lever is in a region between a zero point and a point slightly greater than the zero point, and in a region between a maximum point and a point slightly less than the maximum point, the engine rotational speed setting value is kept constant, and, when the operation amount L of the first or second manipulation lever is in an intermediate region between the above two regions, the engine rotational speed setting value increases or decreases along with an increase or decrease in the operation amount L of the first or second manipulation lever. In the intermediate region where the engine rotational speed setting value increases or decreases along with an increase or decrease in the operation amount L of the first or second manipulation lever, the engine rotational speed setting value increases gradually and linearly along with an increase in the operation amount L of the first or second manipulation lever. Further, an increasing rate of the engine rotational speed setting value with respect to an increase in the operation amount L of the first or second manipulation lever in the intermediate region (an inclination of the primary correlation function in the intermediate region) decreases along with a decrease in the operation amount AC of the accelerator pedal 10a. Under the condition that the operation amount AC of the accelerator pedal 10a is at its maximum value, the engine rotational speed setting value becomes its maximum value (equal to the maximum value Emax of the rotational speed of the engine 2) when the operation amount L of the first or second manipulation lever is equal to or near its maximum value. Under the condition that the operation amount AC of the accelerator pedal 10a is at its minimum value, the engine rotational speed setting value becomes its minimum value (equal to the minimum value Emin of the rotational speed of the engine 2) when the operation amount L of the first or second manipulation lever is equal to or near its minimum value.

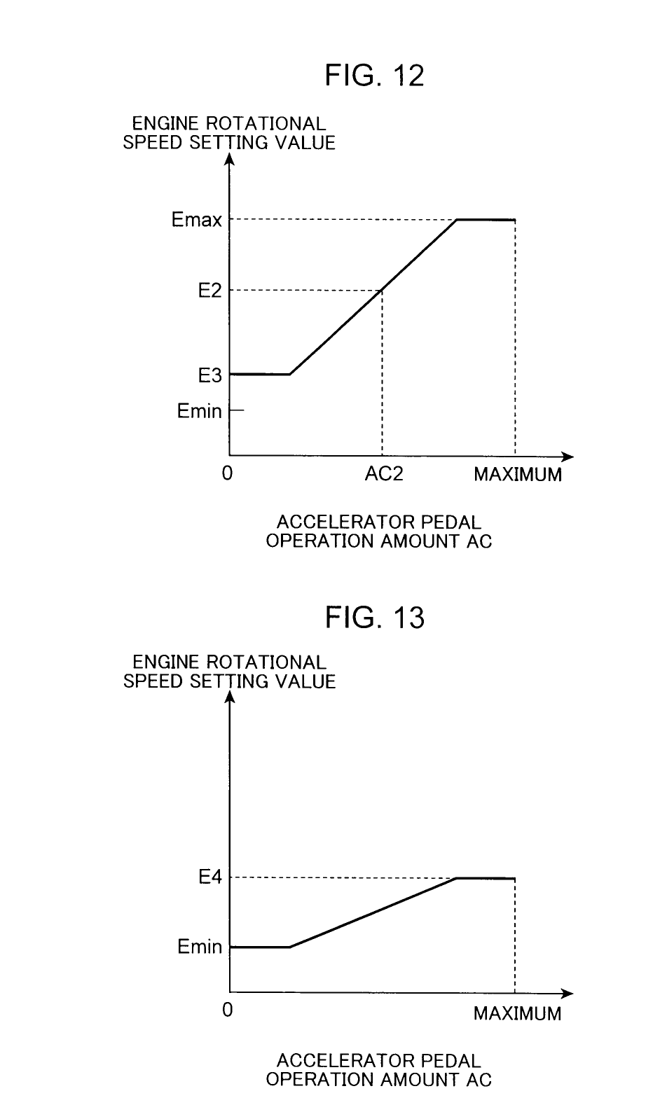

FIG. 12 illustrates the primary correlation function under the condition that the operation amount L of the manipulation lever is set to its maximum value. FIG. 13 illustrates the primary correlation function under the condition that the operation amount L of the manipulation lever is set to its minimum value. As is evidenced from these figures, in the primary correlation function, when the operation amount AC of the accelerator pedal 10a is in a region between a zero point and a point slightly greater than the zero point, and in a region between a maximum point and a point slightly less than the maximum point, the engine rotational speed setting value is kept constant, and, when the operation amount AC of the accelerator pedal 10a is in an intermediate region between the above two regions, the engine rotational speed setting value increases or decreases along with an increase or decrease in the operation amount AC of the accelerator pedal 10a. In the intermediate region where the engine rotational speed setting value increases or decreases along with an increase or decrease in the operation amount AC of the accelerator pedal 10a, the engine rotational speed setting value increases gradually and linearly along with an increase in the operation amount AC of the accelerator pedal 10a. Further, an increasing rate of the engine rotational speed setting value with respect to an increase in the operation amount AC of the accelerator pedal 10a in the intermediate region (an inclination of the primary correlation function in the intermediate region) decreases along with a decrease in the operation amount L of the first or second manipulation lever.

The controller 32 derives an engine rotational speed setting value at a point of the above primary correlation function which corresponds to both of an operation amount L of the first or second manipulation lever detected from the first or second manipulation instruction signal and an operation amount AC of the accelerator pedal 10a detected from the acceleration instruction signal.

The remaining configuration of the engine control apparatus 1 according to the third embodiment is the same as that of the engine control apparatus 1 according to the first embodiment.

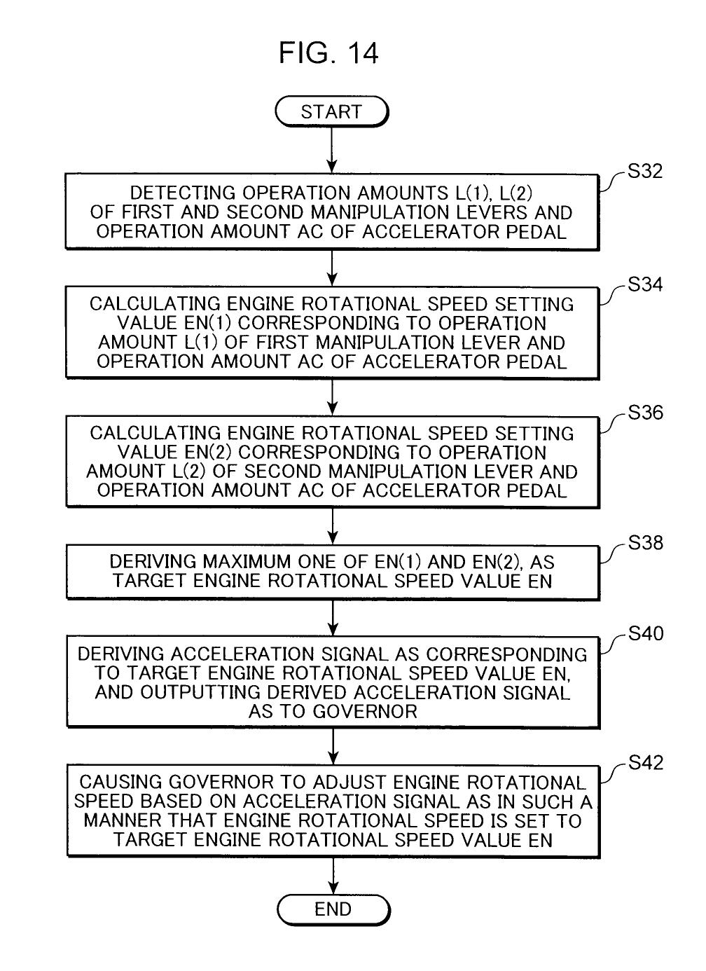

An engine rotational speed control process to be performed by the engine control apparatus 1 according to the third embodiment when the accelerator pedal 10a and the first and second manipulation levers 12a, 14a are simultaneously operated, will be described below. FIG. 14 illustrates the engine rotational speed control process to be performed by the engine control apparatus 1 according to the third embodiment.

In this engine rotational speed control process, the controller 32 detects: an operation amount L(1) of the first manipulation lever 12a based on a first manipulation instruction signal received from the first manipulation device body 12b; an operation amount L(2) of the second manipulation lever 14a based on a second manipulation instruction signal received from the second manipulation device body 14b; and an operation amount AC of the accelerator pedal 10a based on an acceleration instruction signal received from the accelerator device body 10b (Step S32).

Then, based on the primary correlation function, the controller 32 calculates an engine rotational speed setting value EN(1) corresponding to both of the detected operation amount L(1) of the first manipulation lever 12a and the detected operation amount AC of the accelerator pedal 10a (Step S34).

Then, based on the primary correlation function, the controller 32 calculates an engine rotational speed setting value EN(2) corresponding to both of the detected operation amount L(2) of the second manipulation lever 14a and the detected operation amount AC of the accelerator pedal 10a (Step S36).

Subsequently, the controller 32 performs a maximum value selection for selecting a maximum one of the rotational speed setting values EN(1), EN(2), to derive the selected maximum rotational speed setting value, as a target engine rotational speed value EN (Step S38).

Subsequently, the same process as the Steps S16, S18 in the first embodiment is performed as Steps S40, S42, to cause the governor 30 to control the rotational speed of the engine 2.

As described above, in the third embodiment, the controller 32 calculates, based on the primary correlation function, an engine rotational speed setting value EN(1) corresponding to both of a detected operation amount of the first manipulation lever 12a and a detected operation amount of the accelerator pedal 10a, and an engine rotational speed setting value EN(2) corresponding to both of a detected operation amount of the second manipulation lever 14a and the detected operation amount of the accelerator pedal 10a; and derives a maximum one of the calculated engine rotational speed setting values EN(1), EN(2), as a target engine rotational speed value EN. This makes it possible to determine a target value for use in adjusting the rotational speed of the engine 2, even in a situation where the first and second manipulation levers 12a, 14a and the accelerator pedal 10a are simultaneously operated, and change the rotational speed of the engine 2 to the target value.

In the third embodiment, the controller 32 calculates the engine rotational speed setting values EN(1), EN(2), based on the primary correlation function including the region where the engine rotational speed setting value increases or decreases along with an increase or decrease in the operation amount L of the first or second manipulation lever; derives a maximum one of the engine rotational speed setting values EN(1), EN(2), as a target engine rotational speed value EN; and causes the governor 30 to control the rotational speed of the engine 2 according to the target engine rotational speed value EN. Thus, irrespective of the operation amount of the accelerator pedal 10a, the rotational speed of the engine 2 can be adjusted to a value on which an increase or decrease in the operation amount of the first or second manipulation lever 12a or 14a is reflected. Therefore, even when the accelerator pedal 10a has a large operation amount, the engine rotational speed is lowered as the operation amounts of the first and second manipulation levers 12a, 14a are reduced, so that it becomes possible to improve fuel economy.

In the third embodiment, the controller 32 calculates the engine rotational speed setting values EN(1), EN(2), based on the primary correlation function including the region where the engine rotational speed setting value increases or decreases along with an increase or decrease in the operation amount of the accelerator pedal 10a; derives a maximum one of the engine rotational speed setting values EN(1), EN(2), as a target engine rotational speed value EN; and causes the governor 30 to control the rotational speed of the engine 2 according to the target engine rotational speed value EN. Thus, irrespective of the operation amount of each of the first and second manipulation levers 12a, 14b, the rotational speed of the engine 2 can be adjusted to a value on which an increase or decrease in the operation amount of the accelerator pedal 10a is reflected. This makes it possible to perform engine rotational speed control according to the operation of the accelerator pedal 10a, during manipulation of the working devices 6, 8.

In the third embodiment, the controller 32 derives, as a target engine rotational speed value EN, a maximum one of an engine rotational speed setting value EN(1) corresponding to a detected operation amount of the first manipulation lever 12a and a detected operation amount of the accelerator pedal 10a, and an engine rotational speed setting value EN(2) corresponding to a detected operation amount of the second manipulation lever 14a and the detected operation amount of the accelerator pedal 10a. Thus, in a situation where one of the first and second manipulation levers 12a, 14a is manually operated more largely than the other manipulation lever, the rotational speed of the engine 2 is adjusted to a value on which the operation amount of the more-largely-operated manipulation lever is reflected. This makes it possible to controllably adjust the rotational speed of the engine 2 to a value capable of satisfying a movement speed of the working device 6 or 8 according to the manual operation of the more-largely-operated manipulation lever 12a or 14a.

### Fourth Embodiment

A configuration of an engine control apparatus 1 for a working machine, according to a fourth embodiment of the present invention, will be described below.

The engine control apparatus 1 according to the fourth embodiment is used in the same working machine as that employing the engine control apparatus 1 according to the third embodiment. In the engine control apparatus 1 according to the fourth embodiment, instead of deriving a target engine rotational speed value EN by selecting a maximum one of an engine rotational speed setting value EN(1) corresponding to both of a detected operation amount of the first manipulation lever 12a and a detected operation amount of the accelerator pedal 10a, and an engine rotational speed setting value EN(2) corresponding to both of a detected operation amount of the second manipulation lever 14a and the detected operation amount of the accelerator pedal 10a, the controller 32 selects a maximum one of respective detected operation amounts of the first and second manipulation levers 12a, 14a, and calculates an engine rotational speed setting value corresponding to both of the selected maximum operation amount and a detected operation amount of the accelerator pedal 10a, as a target engine rotational speed value EN.

Specifically, the controller 32 selects, in response to receiving first and second manipulation instruction signals output from the first and second manipulation device bodies 12b, 14b, a maximum one of an operation amount of the first manipulation lever 12a indicated by and detected from the first manipulation instruction signal and an operation amount of the second manipulation lever 14a indicated by and detected from the second manipulation instruction signal. Further, the controller 32 calculates, based on a primary correlation function, an engine rotational speed setting value corresponding to both of the selected maximum operation amount of the first or second manipulation lever and an operation amount of the accelerator pedal 10a indicated by and detected from an acceleration instruction signal output from the accelerator device body 10b, and sets the calculated engine rotational speed setting value, as a target engine rotational speed value EN. The primary correlation function used by the controller 32 in the fourth embodiment is the same as that used by the controller 32 in the third embodiment.

The remaining configuration of the engine control apparatus 1 according to the fourth embodiment is the same as that of the engine control apparatus 1 according to the third embodiment.

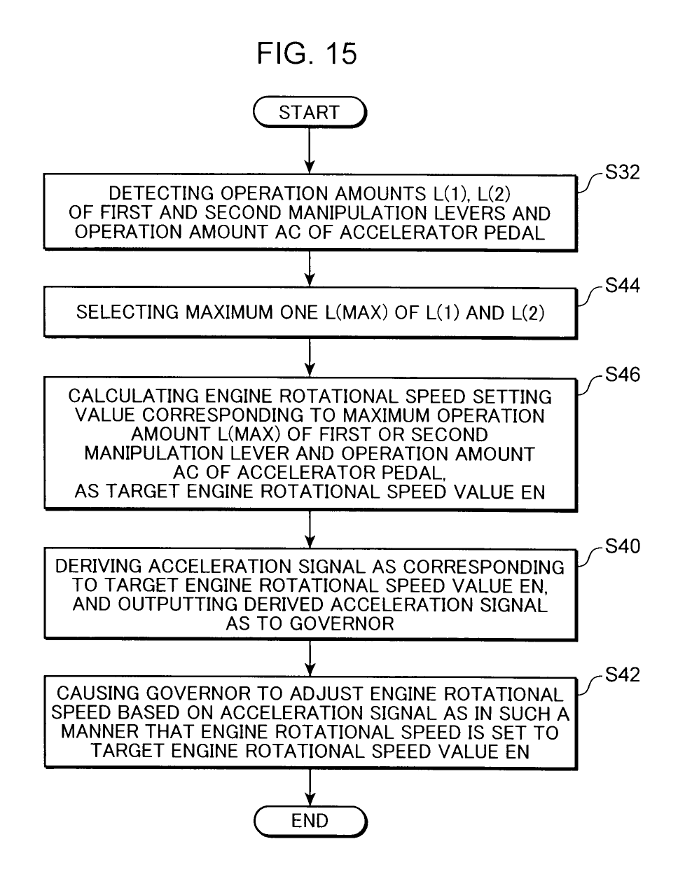

An engine rotational speed control process to be performed by the engine control apparatus 1 according to the fourth embodiment when the accelerator pedal 10a and the first and second manipulation levers 12a, 14a are simultaneously operated, will be described below. FIG. 15 illustrates the engine rotational speed control process to be performed by the engine control apparatus 1 according to the fourth embodiment.

In this engine rotational speed control process, the controller 32 firstly detects an operation amount L(1) of the first manipulation lever 12a, an operation amount L(2) of the second manipulation lever 14a, and an operation amount AC of the acceleration pedal 10a (Step S32), in the same manner as the engine rotational speed control process in the third embodiment.

Then, the controller 32 selects a maximum one L(max) of the detected operation amount L(1) of the first manipulation lever 12a and the detected operation amount L(2) of the second manipulation lever 14a (Step S44).

Subsequently, based on the primary correlation function, the controller 32 calculates an engine rotational speed setting value corresponding to both of the selected maximum operation amount L(max) of the manipulation lever and the detected operation amount AC of the accelerator pedal 10a, as a target engine rotational speed value EN (Step S46).

Subsequently, the controller 32 performs the same process (Steps S40, S42) as that in the third embodiment to cause the governor 30 to control the engine rotational speed 2.

As described above, in the fourth embodiment, the controller 32 calculates a target engine rotational speed value EN based on a maximum one L(max) of respective detected operation amounts L(1), L(2) of the first and second manipulation levers 12a, 14a and a detected operation amount AC of the accelerator pedal 10a. Thus, in a situation where one of the first and second manipulation levers 12a, 14a is manually operated more largely than the other manipulation lever, the rotational speed of the engine 2 is adjusted to a value on which the operation amount of the more-largely-operated manipulation lever is reflected. This makes it possible to controllably adjust the rotational speed of the engine 2 to a value capable of satisfying a movement speed of the working device 6 or 8 according to the manual operation of the more-largely-operated manipulation lever 12a or 14a, as with the third embodiment.

Other effects of the fourth embodiment are the same as those of the third embodiment. It should be noted that the embodiments disclosed here are described by way of example in every respect but not by way of limitation. It is to be understood that the scope of the present invention is not defined by the above embodiments but by the appended claims. Further, legal equivalents of the appended claims and all changes and modifications within the scope of the present invention should be construed as being included therein.

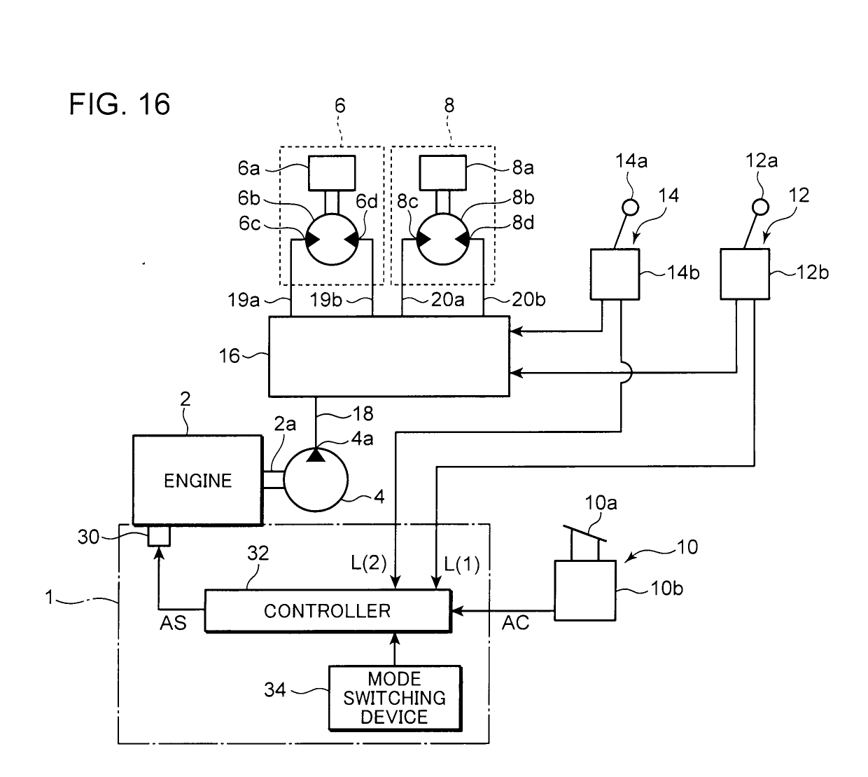

For example, as illustrated in FIG. 16, the engine control apparatus 1 may comprise a mode switching device 34, in addition to the governor 30 and the controller 32. The mode switching device 34 is designed to instruct the controller 32 to switch between a plurality of modes of rotational speed control for the engine 2.

Specifically, the mode switching device 34 is switched between a dual operation-based rotational speed control mode for instructing the controller 32 to perform the rotational speed control for the engine, based on both of the operation of the accelerator pedal 10a and the manual operation of each of the first and second manipulation levers 12a, 14a, and an accelerator operation-based rotational speed control mode for instructing the controller 32 to perform the rotational speed control for the engine, based on only the operation of the accelerator pedal 10a. The mode switching device 34 includes a non-illustrated switch. An operator can operate this switch to change a state of the mode switching device 34 between the dual operation-based rotational speed control mode and the accelerator operation-based rotational speed control mode. The mode switching device 34 sends different signals depending on the modes. The controller 32 performs engine rotational speed control corresponding to the mode indicated by the signal received from the mode switching device 34.

Specifically, in cases where the mode switching device 34 is provided in the engine control apparatus 1 according to one the first and second embodiments, when the mode switching device 34 is in the dual operation-based rotational speed control mode, the controller 32 performs, in response to receiving a signal indicative of the dual operation-based rotational speed control mode from the mode switching device 34, the calculation of a lever operation-related rotational speed setting value, the calculation of an accelerator operation-related rotational speed setting value, and the derivation of a target engine rotational speed value through the lower value selection between the calculated rotational speed setting values, and causes the governor 30 to control the rotational speed of the engine 2 in such a manner that the rotational speed of the engine 2 is set to a value designated by the derived target engine rotational speed value. Further, when the mode switching device 34 is in the accelerator operation-based rotational speed control mode and the controller 32 receives a signal indicative of the accelerator operation-based rotational speed control mode from the mode switching device 34, the controller 32 performs the calculation of an accelerator operation-related rotational speed setting value and causes the governor 30 to control the rotational speed of the engine 2 in such a manner that the rotational speed of the engine 2 is set to a value designated by the calculated accelerator operation-related rotational speed setting value.

In cases where the mode switching device 34 is provided in the engine control apparatus 1 according to one the third and fourth embodiments, when the mode switching device 34 is in the dual operation-based rotational speed control mode, the controller 32 performs, in response to receiving a signal indicative of the dual operation-based rotational speed control mode from the mode switching device 34, the calculation of a target engine rotational speed value corresponding to both of a detected operation amount of the first or second manipulation lever 12a or 14a and a detected operation amount of the accelerator pedal 10a, and causes the governor 30 to control the rotational speed of the engine 2 in such a manner that the rotational speed of the engine 2 is set to a value designated by the calculated target engine rotational speed value. Further, when the mode switching device 34 is in the accelerator operation-based rotational speed control mode and the controller 32 receives a signal indicative of the accelerator operation-based rotational speed control mode from the mode switching device 34, the controller 32 performs the calculation of a rotational speed setting value corresponding to only a detected operation amount of the accelerator pedal 10a, based on a secondary correlation function defining only a relationship between the engine rotational speed setting value and the operation amount of the accelerator pedal 10a, and causes the governor 30 to control the rotational speed of the engine 2 in such a manner that the rotational speed of the engine 2 is set to a value designated by the calculated engine rotational speed setting value. The secondary correlation function is identical to the accelerator operation/rotational speed correlation function illustrated in FIG. 3.

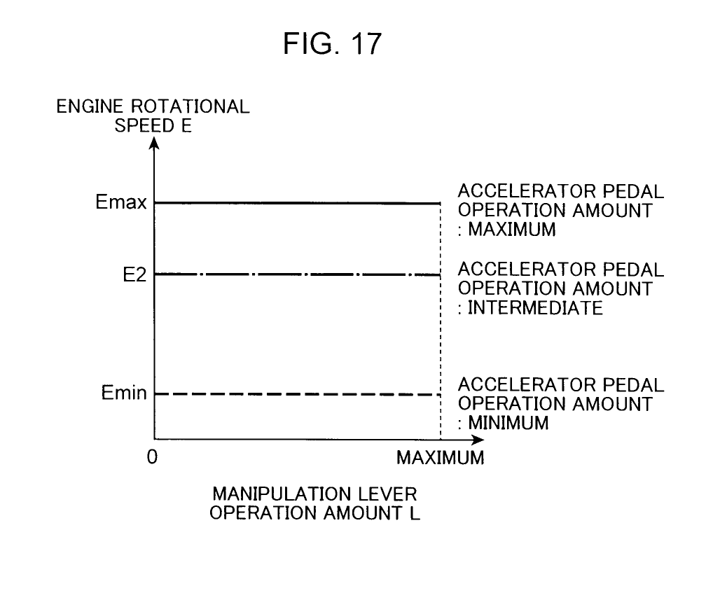

As above, in cases where the mode switching device 34 is provided in the engine control apparatus 1 according to the embodiments, and set to the accelerator operation-based rotational speed control mode, the rotational speed E of the engine 2 increases or decreases along with an increase or decrease of the operation amount of the accelerator pedal 10a as illustrated in FIG. 17, and has a given value irrelevant to the operation amount L of each of the first and second manipulation levers 12a, 14a and corresponding to the operation amount of the accelerator pedal 10a.

In cases where the mode switching device 34 is provided in the engine control apparatus 1 according to one of the first and second embodiments, when the mode switching device 34 is set to the dual operation-based rotational speed control mode, the rotational speed of the engine 2 can be controlled according to a smaller one of the operation of the first or second manipulation lever 12a or 14a and the operation of the accelerator pedal 10a, in terms of an operation amount. On the other hand, when the mode switching device 34 is set to the accelerator operation-based rotational speed control mode, the rotational speed of the engine 2 can be controlled according to only the operation of the accelerator pedal 10a. In cases where the mode switching device 34 is provided in the engine control apparatus 1 according to one of the third and fourth embodiments, when the mode switching device 34 is set to the dual operation-based rotational speed control mode, the rotational speed of the engine 2 can be controlled according to both of the operation of the first or second manipulation lever 12a or 14a and the operation of the accelerator pedal 10a. On the other hand, when the mode switching device 34 is set to the accelerator operation-based rotational speed control mode, the rotational speed of the engine 2 can be controlled according to only the operation of the accelerator pedal 10a. As above, in each of the embodiments, an operator can select a desired one of the engine rotational speed control modes.

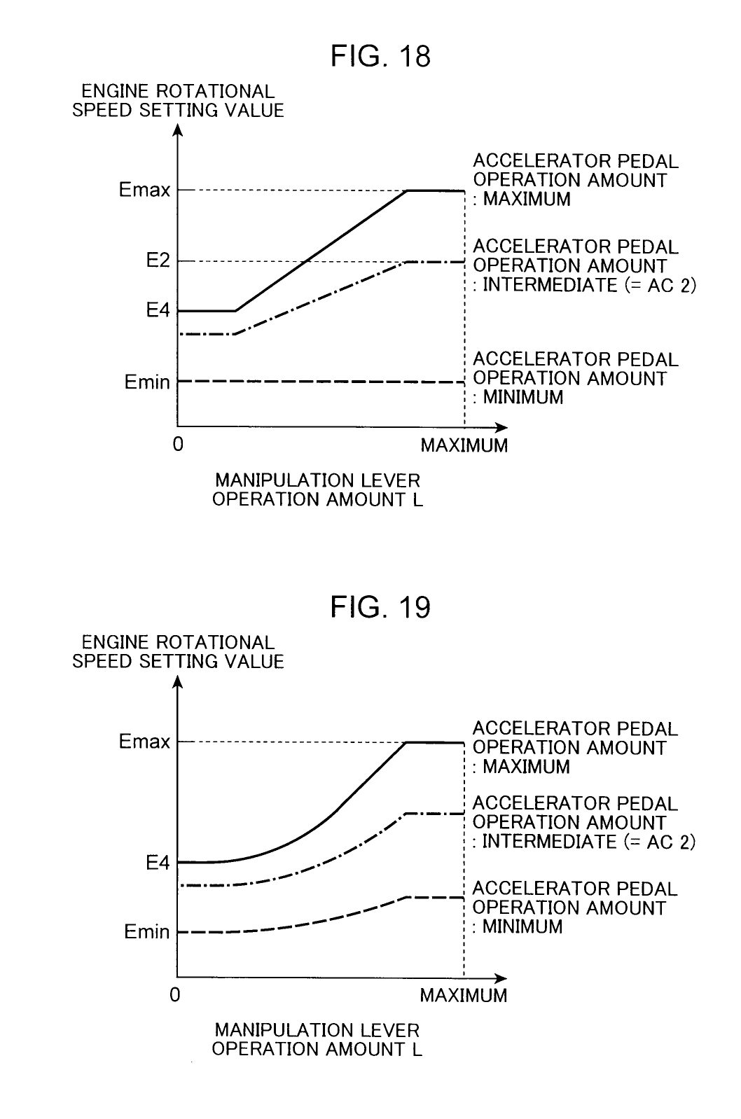

In the above primary correlation function, under the condition that the operation amount of the accelerator pedal 10a is at its minimum value, the engine rotational speed setting value may be kept constant at its minimum value equal to the minimum value Emin of the rotational speed of the engine 2, irrespective of the operation amount L of the first or second manipulation lever 12a or 14a (see FIG. 18).

Further, in the above primary correlation function, in the intermediate region where the engine rotational speed setting value increases or decreases along with an increase or decrease in the operation amount L of the first or second manipulation lever 12a or 14a, the engine rotational speed setting value may be set to gradually increase along with an increase in the operation amount of the first or second manipulation lever, in a curved line (see FIG. 19).

In each of the embodiments, instead of calculating a target engine rotational speed value EN and then converting the target engine rotational speed value EN into an acceleration signal AS, engine rotational speed setting values in each of the functions for calculating an engine rotational speed setting value may be converted into respective values of the acceleration signal AC based on the acceleration signal correlation function to preliminarily produce a modified function, wherein the controller 32 may be configured to, based on the modified function, calculate a value of the acceleration signal AS corresponding to a detected operation amount of the first or second manipulation lever 12a or 14a, or a value of the acceleration signal AS corresponding to a detected operation amount of the accelerator pedal 10a, or a value of the acceleration signal AS corresponding to both of a detected operation amount of the first or second manipulation lever 12a or 14a and a detected operation amount of the accelerator pedal 10a.

In this case, a value of the acceleration signal AS is encompassed within the concept of “rotational speed control target value” set forth in the appended claims. Further, a maximum one of two values of the acceleration signal AS corresponding to respective detected operation amounts of the first and second manipulation levers 12a, 14a, or a value of the acceleration signal AS corresponding to a maximum one of respective detected operation amounts of the first and second manipulation levers 12a, 14a, is encompassed within the concept of “lever operation-related rotational speed control target value” set forth in the appended claims, and a value of the acceleration signal AS corresponding to a detected operation amount of the accelerator pedal 10a is encompassed within the concept of “accelerator operation-related rotational speed control target value” set forth in the appended claims. A maximum one of two values of the acceleration signal AS each corresponding to both of a detected operation amount of a respective one of the first and second manipulation levers 12a, 14a and a detected operation amount of the accelerator pedal 10a, or a value of the acceleration signal AS corresponding to a maximum one of respective operation amounts of the first and second manipulation levers 12a, 14a and the detected operation amount of the accelerator pedal 10a, is encompassed within the concept of “rotational speed control command value” set forth in the appended claims. A modified function produced by converting engine rotational speed setting values in the lever operation/rotational speed correlation function into values of the accelerator signal AS is encompassed within the concept of “lever operation/rotational speed correlation function” set forth in the appended claims, and a modified function produced by converting engine rotational speed setting values in the accelerator operation/rotational speed correlation function into values of the accelerator signal AS is encompassed within the concept of “accelerator operation/rotational speed correlation function” set forth in the appended claims. Further, a modified function produced by converting engine rotational speed setting values in the primary correlation function into values of the accelerator signal AS is encompassed within the concept of “primary correlation function” set forth in the appended claims, and a modified function produced by converting engine rotational speed setting values in the secondary correlation function into values of the accelerator signal AS is encompassed within the concept of “secondary correlation function” set forth in the appended claims.

In the first embodiment, the lever operation/rotational speed correlation function used by the controller 32 for calculating an engine rotational speed setting value EN1(1) corresponding to a detected operation amount L(1) of the first manipulation lever 12a, and the lever operation/rotational speed correlation function used by the controller 32 for calculating an engine rotational speed setting value EN1(2) corresponding to a detected operation amount L(2) of the second manipulation lever 14a, are not necessarily identical to each other. For example, it is possible to employ two types of lever operation/rotational speed correlation functions each suitable for a movement characteristic of a respective one of the working devices 6, 8 to be manipulated by the first and second manipulation levers 12a, 14a.

Further, in the third embodiment, the primary correlation function used by the controller 32 for calculating an engine rotational speed setting value EN(1) corresponding to a detected operation amount L(1) of the first manipulation lever 12a and a detected operation amount AC of the acceleration pedal 10a, and the primary correlation function used by the controller 32 for calculating an engine rotational speed setting value EN(2) corresponding to a detected operation amount L(2) of the second manipulation lever 14a and the detected operation amount AC of the acceleration pedal 10a, are not necessarily identical to each other. For example, it is possible to employ two types of primary correlation functions each suitable for a movement characteristic of a respective one of the working devices 6, 8 to be manipulated by the first and second manipulation levers 12a, 14a.

The engine control apparatus of the present invention may be used in various working machines other than a crane. For example, the engine control apparatus of the present invention may be used in a hydraulic shovel or the like. In cases where the engine control apparatus of the present invention is used in a hydraulic shovel, the working device may include an attachment and a backhoe. The actuator of the working device is not limited to a hydraulic motor. In cases where the working device is an attachment or a backhoe, the actuator thereof may be a hydraulic cylinder.

The accelerator member of the present invention is not limited to the accelerator pedal 10, but may be any other suitable type.

Each of the number of working machines and the number of manipulation levers (manipulation devices) is not limited to two. For example, as a working device and a manipulation lever of a working machine implementing the present invention, a single working device and a single manipulation lever (manipulation device) may be provided in the working machine. In this case, the controller 32 may be configured to calculate a manipulation lever-related rotational speed setting value according to a detected operation amount of the single manipulation lever, without performing the selection of a maximum one of respective engine rotational speed setting values each corresponding to a detected operation amount of a respective one of a plurality of manipulation levers or the selection of a maximum one of respective detected operation amounts of a plurality of manipulation levers as described above. Alternatively, as a working device and a manipulation lever of a working machine implementing the present invention, three or more working devices and three or more manipulation levers (manipulation devices) may be provided in the working machine. In this case, the controller 32 may be configured to perform the selection of a maximum one of respective engine rotational speed setting values each corresponding to a detected operation amount of the three or more manipulation levers, and set the selected maximum value as a manipulation lever-related rotational speed setting value; or the controller 32 may be configured to perform the selection of a maximum one of respective detected operation amounts of the three or more manipulation levers, and derive a rotational speed control target value corresponding to the selected maximum operation amount, as a manipulation lever-related rotational speed setting value.

### Outline of the Embodiments and Modifications

The outline of the above embodiment and modification is as follows.

In one aspect of the above embodiments and modifications, there is provided an engine control apparatus for use in a working machine which includes an engine for generating power, a working device performing a given movement using the power generated by the engine, an accelerator member operated for changing a rotational speed of the engine, and a manipulation lever operated for actuating the working device, wherein the engine control apparatus controls the rotational speed of the engine. The engine control apparatus comprises a governor attached to the engine to control the rotational speed of the engine, and a controller which derives a lever operation-related rotational speed control target value which is a rotational speed control target value corresponding to a detected operation amount of the manipulation lever, based on a lever operation/rotational speed correlation function defining a relationship between a rotational speed control target value for the engine and an operation amount of the manipulation lever; derives an accelerator operation-related rotational speed control target value which is a rotational speed control target value corresponding to a detected operation amount of the accelerator member, based on an accelerator operation/rotational speed correlation function defining a relationship between the rotational speed control target value and the operation amount of the accelerator member; performs a lower value selection for selecting a lower one of the derived lever operation-related rotational speed control target value and accelerator operation-related rotational speed control target value; and causes the governor to control the rotational speed of the engine in such a manner that the rotational speed of the engine is set to the rotational speed control target value selected by the lower value selection.

In the above engine control apparatus, the controller performs a lower value selection between an accelerator operation-related rotational speed control target value corresponding to a detected operation amount of the accelerator member and a lever operation-related rotational speed control target value corresponding to a detected operation amount of the manipulation lever; and causes the governor to control the rotational speed of the engine in such a manner that the rotational speed of the engine is set to a value designated by the rotational speed control target value selected by the lower value selection. This makes it possible to determine a target value for use in adjusting the rotational speed of the engine, even in a situation where the accelerator member and the manipulation lever are simultaneously operated, and change the rotational speed of the engine to the target value. Further, in the above engine control apparatus, the controller causes the governor to control rotational speed of the engine, based on the rotational speed control target value selected through a lower value selection between the accelerator operation-related rotational speed control target value and the lever operation-related rotational speed control target value, so that, when the lever operation-related rotational speed control target value corresponding to the detected operation amount of the manipulation lever is lower than the accelerator operation-related rotational speed control target value corresponding to the detected operation amount of the accelerator member, the rotational speed of the engine is set to a value corresponding to the detected operation amount of the manipulation lever. This prevents the occurrence of a situation where the rotational speed of the engine is unnecessarily increased along with an increase in the operation amount of the accelerator member although the manipulation lever has a small operation amount, which makes it possible to improved fuel economy. In the above engine control apparatus, the controller causes the governor to control rotational speed of the engine, based on the rotational speed control target value selected through a lower value selection between the accelerator operation-related rotational speed control target value and the lever operation-related rotational speed control target value, so that, in a range where the accelerator operation-related rotational speed control target value corresponding to the detected operation amount of the accelerator member is lower than the lever operation-related rotational speed control target value corresponding to the detected operation amount of the manipulation lever, the engine rotational speed control is performed according to the operation of the accelerator member. Thus, when the manipulation lever is operated in a large amount during manipulation of the working device, the rotational speed of the engine can be adjusted to a value based on the operation of the accelerator member.

In cases where the above engine control apparatus is used in the working machine which includes a plurality of the working devices each performing a given movement and a plurality of the manipulation levers each operated for actuating a respective one of the working devices, the controller may derive, based on the lever operation/rotational speed correlation function, a plurality of rotational speed control target values each corresponding to a detected operation amount of a respective one of the plurality of manipulation levers, and derive a maximum one of the plurality of derived rotational speed control target values, as the lever operation-related rotational speed control target value.

Alternatively, in cases where the engine control apparatus is used in the working machine which includes a plurality of the working devices each performing a given movement and a plurality of the manipulation levers each operated for actuating a respective one of the working devices, the controller may select a maximum one of respective detected operation amounts of the plurality of manipulation levers; and derive, based on the lever operation/rotational speed correlation function, a rotational speed control target value corresponding to the selected maximum operation amount, as the lever operation-related rotational speed control target value.

According to these features, in a situation where one of the plurality of manipulation levers is operated most largely, when a rotational speed control target value corresponding to a detected operation amount of the most-largely-operated manipulation lever is lower than the accelerator operation-related rotational speed control target value, the rotational speed of the engine is controlled according to the detected operation amount of the most-largely-operated manipulation lever. In the situation one of the plurality of manipulation levers is operated most largely, one of the working devices to be manipulated according to the operation of the most-largely-operated manipulation lever is generally required to be most quickly moved. In the above engine control apparatus, the rotational speed of the engine is controlled according to the detected operation amount of the most-largely-operated manipulation lever. This makes it possible to controllably adjust the rotational speed of the engine to a value capable of satisfying a movement speed of the working device according to the operation of the most-largely-operated manipulation lever.

The above engine control apparatus may further comprise a mode switching device adapted to be switched between a dual operation-based rotational speed control mode for instructing the controller to perform the rotational speed control for the engine, based on both of the operation of the accelerator member and the operation of the manipulation lever, and an accelerator operation-based rotational speed control mode for instructing the controller to perform the rotational speed control for the engine, based on only the operation of the accelerator member, wherein, when the mode switching device is in the dual operation-based rotational speed control mode, the controller may derive a lever operation-related rotational speed control target value, derive an accelerator operation-related rotational speed control target value, perform the lower value selection and cause the governor to control the rotational speed of the engine in such a manner that the rotational speed of the engine is set to a rotational speed control target value selected by the lower value selection; and, when the mode switching device is in the accelerator operation-based rotational speed control mode, the controller may derive an accelerator operation-related rotational speed control target value and cause the governor to control the rotational speed of the engine in such a manner that the rotational speed of the engine is set to the derived accelerator operation-related rotational speed control target value.

According to this feature, when the mode switching device is set to the dual operation-based rotational speed control mode, the rotational speed of the engine can be controlled according to a smaller one of the operations of the accelerator member and the manipulation lever in terms of an operation amount. On the other hand, when the mode switching device is set to the accelerator operation-based rotational speed control mode, the rotational speed of the engine can be controlled according to only the operation of the accelerator member. Thus, an operator can select a desired one of the engine rotational speed control modes.

In another aspect of the above embodiments and modifications, there is provided an engine control apparatus for use in a working machine which includes an engine for generating power, a working device performing a given movement using the power generated by the engine, an accelerator member operated for changing a rotational speed of the engine, and a manipulation lever operated for actuating the working device, wherein the engine control apparatus controls the rotational speed of the engine. The engine control apparatus comprises a governor attached to the engine to control the rotational speed of the engine, and a controller which derives a rotational speed control command value which is a rotational speed control target value corresponding to both of a detected operation amount of the manipulation lever and a detected operation amount of the accelerator member, based on a primary correlation function which defines a mutual relationship of a rotational speed control target value for the engine, an operation amount of the manipulation lever and an operation amount of the accelerator member, and includes a region where the rotational speed control target value increases or decreases along with an increase or decrease in the operation amount of the manipulation lever and a region where the rotational speed control target value increases or decreases along with an increase or decrease in the operation amount of the accelerator member; and causes the governor to control the rotational speed of the engine in such a manner that the rotational speed of the engine is set to the derived rotational speed control command value.

In this engine control apparatus, the controller can derive a rotational speed control command value corresponding to both of a detected operation amount of the accelerator member and a detected operation amount of the manipulation lever, based on the primary correlation function, so that it becomes possible to determine a target value for use in adjusting the rotational speed of the engine, even in a situation where the accelerator member and the manipulation lever are simultaneously operated. In this engine control apparatus, the controller derives the rotational speed control command value, based on the primary correlation function including the region where the rotational speed control target value increases or decreases along with an increase or decrease in the operation amount of the manipulation lever, and causes the governor to control the rotational speed of the engine according to the rotational speed control command value. Thus, irrespective of the operation amount of the accelerator member, the rotational speed of the engine can be controllably adjusted to a value on which an increase or decrease in the operation amount of the manipulation lever is reflected. Therefore, even when the accelerator member has a large operation amount, the engine rotational speed is lowered as the operation amount of the manipulation lever is reduced, so that it becomes possible to improve fuel economy. In this engine control apparatus, the controller derives the rotational speed control command value based on the primary correlation function including the region where the rotational speed control target value increases or decreases along with an increase or decrease in the operation amount of the accelerator member, and causes the governor to control the rotational speed of the engine according to the rotational speed control command value. Thus, irrespective of the operation amount of the manipulation lever, the rotational speed of the engine can be controllably adjusted to a value on which an increase or decrease in the operation amount of the accelerator member is reflected. This makes it possible to perform engine rotational speed control according to the operation of the accelerator member, during manipulation of the working device.

In cases where the engine control apparatus comprising the controller configured to derive a rotational speed control command value corresponding to both of a detected operation amount of the manipulation lever and a detected operation amount of the accelerator member is used in a working machine which includes a plurality of the working devices each performing a given movement and a plurality of the manipulation levers each operated for actuating a respective one of the working devices, the controller may derive, based on the primary correlation function, a plurality of rotational speed control target values each corresponding to a detected operation amount of a respective one of the plurality of manipulation levers and a detected operation amount of the accelerator member, and derive a maximum one of the plurality of derived rotational speed control target values, as the rotational speed control command value.

Alternatively, in cases where the engine control apparatus comprising the controller configured to derive a rotational speed control command value corresponding to both of a detected operation amount of the manipulation lever and a detected operation amount of the accelerator member is used in a working machine which includes a plurality of the working devices each performing a given movement, and a plurality of the manipulation levers each operated for actuating a respective one of the working devices, the controller may select a maximum one of respective detected operation amounts of the plurality of manipulation levers, and, based on the primary correlation function, derive a rotational speed control target value corresponding to the selected maximum operation amount and a detected operation amount of the accelerator member, as the rotational speed control command value.

According to these features, in a situation where one of the plurality of manipulation levers is operated most largely, the rotational speed of the engine is controlled according to the detected operation amount of the most-largely-operated manipulation lever. In the situation one of the plurality of manipulation levers is operated most largely, one of the working devices to be manipulated according to the operation of the most-largely-operated manipulation lever is generally required to be most quickly moved. In the above engine control apparatus, the rotational speed of the engine is controlled according to the detected operation amount of the most-largely-operated manipulation lever. This makes it possible to controllably adjust the rotational speed of the engine to a value capable of satisfying a movement speed of the working device according to the operation of the most-largely-operated manipulation lever.

In the configuration that the engine control apparatus have the controller which derives, based on the primary correlation function, a rotational speed control command value corresponding to both of a detected operation amount of the manipulation lever and a detected operation amount of the accelerator member, the engine control apparatus may further comprise a mode switching device adapted to be switched between a dual operation-based rotational speed control mode for instructing the controller to perform the rotational speed control for the engine based on both of the operation of the accelerator member and the operation of the manipulation lever, and an accelerator operation-based rotational speed control mode for instructing the controller to perform the rotational speed control for the engine based on only the operation of the accelerator member, wherein, when the mode switching device is in the dual operation-based rotational speed control mode, the controller may derive a rotational speed control command value corresponding to both of a detected operation amount of the manipulation lever and a detected operation amount of the accelerator member, and cause the governor to control the rotational speed of the engine in such a manner that the rotational speed of the engine is set to the derived rotational speed control command value, and, when the mode switching device is in the accelerator operation-based rotational speed control mode, the controller may derive a rotational speed control target value corresponding to only a detected operation amount of the accelerator member, based on a secondary correlation function defining only a relationship between the rotational speed control target value and the operation amount of the accelerator member, and cause the governor to control the rotational speed of the engine in such a manner that the rotational speed of the engine is set to the derived rotational speed control target value.

According to this feature, when the mode switching device is set to the dual operation-based rotational speed control mode, the rotational speed of the engine can be controlled according to both of the operations of the accelerator member and the manipulation lever. On the other hand, when the mode switching device is set to the accelerator operation-based rotational speed control mode, the rotational speed of the engine can be controlled according to only the operation of the accelerator member. Thus, an operator can select a desired one of the engine rotational speed control modes.

As described above, the engine control apparatus according to each of the above embodiments and modifications is capable of setting a rotational speed of an engine even when an accelerator member and a manipulation lever are simultaneously operated, while achieving improvement in fuel economy and engine rotational speed control based on the operation of the accelerator member during manipulation of a working device.

This application is based on Japanese Patent application No. 2010-272943 filed in Japan Patent Office on Dec. 7, 2010, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An engine control apparatus for use in a working machine which includes an engine for generating power, a working device performing a given movement using the power generated by the engine, an accelerator member operated for changing a rotational speed of the engine, and a manipulation lever operated for actuating the working device, wherein the engine control apparatus controls the rotational speed of the engine, the engine control apparatus comprising:
a governor attached to the engine to control the rotational speed of the engine; and
a controller which derives a lever operation-related rotational speed control target value which is a rotational speed control target value corresponding to a detected operation amount of the manipulation lever, based on a lever operation/rotational speed correlation function defining a relationship between a rotational speed control target value for the engine and an operation amount of the manipulation lever; derives an accelerator operation-related rotational speed control target value which is a rotational speed control target value corresponding to a detected operation amount of the accelerator member, based on an accelerator operation/rotational speed correlation function defining a relationship between the rotational speed control target value and the operation amount of the accelerator member; performs a lower value selection for selecting a lower one of the derived lever operation-related rotational speed control target value and accelerator operation-related rotational speed control target value; and causes the governor to control the rotational speed of the engine in such a manner that the rotational speed of the engine is set to the rotational speed control target value selected by the lower value selection.

2. The engine control apparatus as defined in claim 1, wherein the engine control apparatus is used in the working machine which includes a plurality of the working devices each performing a given movement and a plurality of the manipulation levers each operated for actuating a respective one of the working devices, and wherein the controller derives, based on the lever operation/rotational speed correlation function, a plurality of rotational speed control target values each corresponding to a detected operation amount of a respective one of the plurality of manipulation levers, and derives a maximum one of the plurality of derived rotational speed control target values, as the lever operation-related rotational speed control target value.

3. The engine control apparatus as defined in claim 1, wherein the engine control apparatus is used in the working machine which includes a plurality of the working devices each performing a given movement and a plurality of the manipulation levers each operated for actuating a respective one of the working devices, and wherein the controller selects a maximum one of respective detected operation amounts of the plurality of manipulation levers; and derives, based on the lever operation/rotational speed correlation function, a rotational speed control target value corresponding to the selected maximum operation amount, as the lever operation-related rotational speed control target value.

4. The engine control apparatus as defined in claim 1, further comprising a mode switching device adapted to be switched between a dual operation-based rotational speed control mode for instructing the controller to perform the rotational speed control for the engine based on both of the operation of the accelerator member and the operation of the manipulation lever, and an accelerator operation-based rotational speed control mode for instructing the controller to perform the rotational speed control for the engine based on only the operation of the accelerator member,
wherein, when the mode switching device is in the dual operation-based rotational speed control mode, the controller derives a lever operation-related rotational speed control target value, derives an accelerator operation-related rotational speed control target value, performs the lower value selection and causes the governor to control the rotational speed of the engine in such a manner that the rotational speed of the engine is set to a rotational speed control target value selected by the lower value selection; and, when the mode switching device is in the accelerator operation-based rotational speed control mode, the controller derives an accelerator operation-related rotational speed control target value and causes the governor to control the rotational speed of the engine in such a manner that the rotational speed of the engine is set to the derived accelerator operation-related rotational speed control target value.

5. The engine control apparatus as defined in claim 2, further comprising a mode switching device adapted to be switched between a dual operation-based rotational speed control mode for instructing the controller to perform the rotational speed control for the engine based on both of the operation of the accelerator member and the operation of the manipulation lever, and an accelerator operation-based rotational speed control mode for instructing the controller to perform the rotational speed control for the engine based on only the operation of the accelerator member,
wherein, when the mode switching device is in the dual operation-based rotational speed control mode, the controller derives a lever operation-related rotational speed control target value, derives an accelerator operation-related rotational speed control target value, performs the lower value selection and causes the governor to control the rotational speed of the engine in such a manner that the rotational speed of the engine is set to a rotational speed control target value selected by the lower value selection; and, when the mode switching device is in the accelerator operation-based rotational speed control mode, the controller derives an accelerator operation-related rotational speed control target value and causes the governor to control the rotational speed of the engine in such a manner that the rotational speed of the engine is set to the derived accelerator operation-related rotational speed control target value.

6. The engine control apparatus as defined in claim 3, further comprising a mode switching device adapted to be switched between a dual operation-based rotational speed control mode for instructing the controller to perform the rotational speed control for the engine based on both of the operation of the accelerator member and the operation of the manipulation lever, and an accelerator operation-based rotational speed control mode for instructing the controller to perform the rotational speed control for the engine based on only the operation of the accelerator member,
wherein, when the mode switching device is in the dual operation-based rotational speed control mode, the controller derives a lever operation-related rotational speed control target value, derives an accelerator operation-related rotational speed control target value, performs the lower value selection and causes the governor to control the rotational speed of the engine in such a manner that the rotational speed of the engine is set to a rotational speed control target value selected by the lower value selection; and, when the mode switching device is in the accelerator operation-based rotational speed control mode, the controller derives an accelerator operation-related rotational speed control target value and causes the governor to control the rotational speed of the engine in such a manner that the rotational speed of the engine is set to the derived accelerator operation-related rotational speed control target value.

7. An engine control apparatus for use in a working machine which includes an engine for generating power, a working device performing a given movement using the power generated by the engine, an accelerator member operated for changing a rotational speed of the engine, and a manipulation lever operated for actuating the working device, wherein the engine control apparatus controls the rotational speed of the engine, the engine control apparatus comprising:
a governor attached to the engine to control the rotational speed of the engine; and
a controller which derives a rotational speed control command value which is a rotational speed control target value corresponding to both of a detected operation amount of the manipulation lever and a detected operation amount of the accelerator member, based on a primary correlation function which defines a mutual relationship of a rotational speed control target value for the engine, an operation amount of the manipulation lever and an operation amount of the accelerator member, and includes a region where the rotational speed control target value increases or decreases along with an increase or decrease in the operation amount of the manipulation lever and a region where the rotational speed control target value increases or decreases along with an increase or decrease in the operation amount of the accelerator member; and causes the governor to control the rotational speed of the engine in such a manner that the rotational speed of the engine is set to the derived rotational speed control command value.

8. The engine control apparatus as defined in claim 7, wherein the engine control apparatus is used in the working machine which includes a plurality of the working devices each performing a given movement and a plurality of the manipulation levers each operated for actuating a respective one of the working devices, and wherein the controller derives, based on the primary correlation function, a plurality of rotational speed control target values each corresponding to a detected operation amount of a respective one of the plurality of manipulation levers and a detected operation amount of the accelerator member, and derives a maximum one of the plurality of derived rotational speed control target values, as the rotational speed control command value.

9. The engine control apparatus as defined in claim 7, wherein the engine control apparatus is used in the working machine which includes a plurality of the working devices each performing a given movement and a plurality of the manipulation levers each operated for actuating a respective one of the working devices, and wherein the controller selects a maximum one of respective detected operation amounts of the plurality of manipulation levers; and derives, based on the primary correlation function, a rotational speed control target value corresponding to the selected maximum operation amount and a detected operation amount of the accelerator member, as the rotational speed control command value.

10. The engine control apparatus as defined in claim 7, further comprising a mode switching device adapted to be switched between a dual operation-based rotational speed control mode for instructing the controller to perform the rotational speed control for the engine based on both of the operation of the accelerator member and the operation of the manipulation lever, and an accelerator operation-based rotational speed control mode for instructing the controller to perform the rotational speed control for the engine based on only the operation of the accelerator member,
wherein, when the mode switching device is in the dual operation-based rotational speed control mode, the controller derives a rotational speed control command value corresponding to both of a detected operation amount of the manipulation lever and a detected operation amount of the accelerator member, and causes the governor to control the rotational speed of the engine in such a manner that the rotational speed of the engine is set to the derived rotational speed control command value; and, when the mode switching device is in the accelerator operation-based rotational speed control mode, the controller derives a rotational speed control target value corresponding to only a detected operation amount of the accelerator member, based on a secondary correlation function defining only a relationship between the rotational speed control target value and the operation amount of the accelerator member, and causes the governor to control the rotational speed of the engine in such a manner that the rotational speed of the engine is set to the derived rotational speed control target value.

11. The engine control apparatus as defined in claim 8, further comprising a mode switching device adapted to be switched between a dual operation-based rotational speed control mode for instructing the controller to perform the rotational speed control for the engine based on both of the operation of the accelerator member and the operation of the manipulation lever, and an accelerator operation-based rotational speed control mode for instructing the controller to perform the rotational speed control for the engine based on only the operation of the accelerator member,
wherein, when the mode switching device is in the dual operation-based rotational speed control mode, the controller derives a rotational speed control command value corresponding to both of a detected operation amount of the manipulation lever and a detected operation amount of the accelerator member, and causes the governor to control the rotational speed of the engine in such a manner that the rotational speed of the engine is set to the derived rotational speed control command value; and, when the mode switching device is in the accelerator operation-based rotational speed control mode, the controller derives a rotational speed control target value corresponding to only a detected operation amount of the accelerator member, based on a secondary correlation function defining only a relationship between the rotational speed control target value and the operation amount of the accelerator member, and causes the governor to control the rotational speed of the engine in such a manner that the rotational speed of the engine is set to the derived rotational speed control target value.

12. The engine control apparatus as defined in claim 9, further comprising a mode switching device adapted to be switched between a dual operation-based rotational speed control mode for instructing the controller to perform the rotational speed control for the engine based on both of the operation of the accelerator member and the operation of the manipulation lever, and an accelerator operation-based rotational speed control mode for instructing the controller to perform the rotational speed control for the engine based on only the operation of the accelerator member,
wherein, when the mode switching device is in the dual operation-based rotational speed control mode, the controller derives a rotational speed control command value corresponding to both of a detected operation amount of the manipulation lever and a detected operation amount of the accelerator member, and causes the governor to control the rotational speed of the engine in such a manner that the rotational speed of the engine is set to the derived rotational speed control command value; and, when the mode switching device is in the accelerator operation-based rotational speed control mode, the controller derives a rotational speed control target value corresponding to only a detected operation amount of the accelerator member, based on a secondary correlation function defining only a relationship between the rotational speed control target value and the operation amount of the accelerator member, and causes the governor to control the rotational speed of the engine in such a manner that the rotational speed of the engine is set to the derived rotational speed control target value.
